(19) United States
(12) Patent Application Publication
(10) Pub. No.: US 2015/0344816 A1
(43) Pub. Date: Dec. 3, 2015

(54) DERIVATIVES OF FATTY ESTERS, FATTY ACIDS AND ROSINS

(71) Applicant: WASHINGTON STATE UNIVERSITY RESEARCH FOUNDATION, Pullman, WA (US)

(72) Inventors: Jinwen Zhang, Pullman, WA (US); Pei Zhang, Pullman, WA (US)

(21) Appl. No.: 14/761,268

(22) PCT Filed: Jan. 24, 2014
(86) PCT No.: PCT/US14/13017

§ 371 Date: Jul. 15, 2015

Related U.S. Application Data
(60) Provisional application No. 61/756,917, filed on Jan. 25, 2013.

(51) Int. Cl. C11C 3/04; C08F 222/14

(52) U.S. Cl. CPC C11C 3/04; C08F 222/14

(57) ABSTRACT

Provided is a compound of Formula (I); where R¹, R², L₁ and L₂ are as described herein. The compound of Formula I and copolymers thereof can be used as epoxy resins, curing agents, flame retardants, UV curable agents and the like. A process for preparing the compound of Formula (I) is also provided.

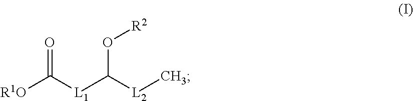

### RELATED APPLICATION

This application is a PCT application that claims the benefit of U.S. Provisional Application No. 61/756,917, filed on Jan. 25, 2013, the contents of which are incorporated herein by reference in their entirety.

### FIELD

The present technology generally relates to derivatives of fatty acids, fatty esters and rosin acids, and methods of preparing the same. These derivatives can be made into co-polymers or resins for use in numerous applications.

### BACKGROUND

Many industrial products include polymers made from petroleum-based unsaturated polyesters that have been co-polymerized with polymerizable monomers such as styrene. There is a demand for industrial products that are made from unsaturated feedstocks which are not petroleum based. Naturally occurring unsaturated fatty esters and fatty acids, such as vegetable oils, have been of limited use in this regard because these oils, relative to petroleum-based unsaturated polyesters, are less prone to react with polymerizable monomers such as styrene. Consequently, unsaturated fatty esters or fatty acids require modification of their double bonds to more readily react with polymerizable monomers. Various methods are known in the art for converting unsaturated fatty esters and fatty acids to derivatized forms having more accessible olefin moieties. These methods typically include multiple step conversions where, for example, a reactive hydroxyl “handle” is introduced into the double bonds of an unsaturated fatty ester or fatty acid. The reactive hydroxyl handle can be further derivatized by the addition of an acrylate functionality which renders the acid or ester derivative more reactive and allows it to co-polymerize with polymerizable monomers such as styrene. However, it remains difficult to directly introduce a polymerizable moiety, such as an acrylate functionality, into the double bond of naturally occurring unsaturated fatty esters and fatty acids. Improved methods are needed.

### SUMMARY

In one aspect, a compound of Formula I is provided:

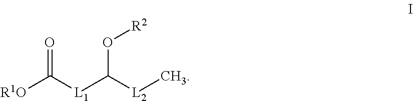

In Formula I, R¹ is H, alkyl or

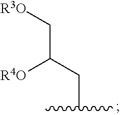

R³ and R⁴ are independently

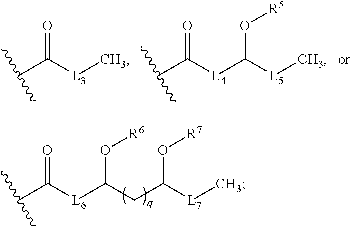

R², R⁵, R⁶ and R⁷ are independently CO(CH₂)ₘSH, CO(CH₂)ₘP(O)(OR⁸)(R⁹), P(O)(OR¹⁹)₂, P(O)(OH)₂, COC(R¹⁰)═CHR¹⁹, or COC(R¹⁰)═CH₂;
R⁸ is H, alkyl, or aryl;
R⁹ is H, alkyl, or aryl;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene or C₂-C₂₂ alkenylene;
m is 1 to 6; and
q is 1 to 6.

In an embodiment, where R⁸ and R⁹ are each an aryl, R⁸ and R⁹ can be joined together by a single bond.

In another aspect, a compound of Formula Ia is provided:

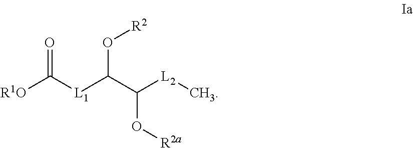

In Formula I, R¹ is H, alkyl or

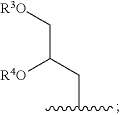

R³ and R⁴ are independently

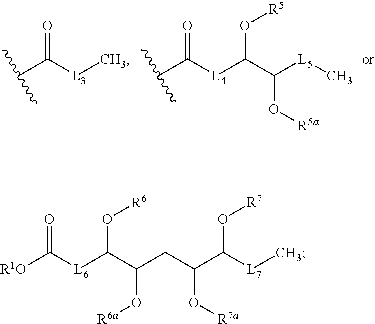

R², R⁵, R^{5a}, R⁶, R^{6a}, R⁷ and R^{7a} are independently CO(CH₂)ₘ SH, CO(CH₂)ₘP(O)(OR⁸)(R⁹), P(O)(OR¹⁹)₂, P(O)(OH)₂, COC(R¹⁰)═CHR¹⁹, or COC(R¹⁰)═CH₂;
R⁸ is H, alkyl, or aryl;
R⁹ is H, alkyl, or aryl; or
   R⁸ and R⁹ may both be aryl joined together by a single bond;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene; and
m is 1 to 6.

In another aspect, a process is provided for preparing a compound of Formula I, the process comprising: mixing a compound selected from the group consisting of (HO)CO(CH₂)ₘSH, (HO)CO(CH₂)ₘP(O)(OR⁸)(R⁹), (HO)P(O)(OR¹⁹)₂, (HO)OP(O)(OH)₂ and (HO)COC(R¹⁰)═CH₂; a catalyst; and a C₈-C₃₀ unsaturated fatty acid or a C₈-C₃₀ unsaturated fatty ester to form the compound of Formula I.

In another aspect, a process is provided for preparing a compound of Formula Ia, the process comprising contacting a C₈-C₃₀ unsaturated fatty acid or a C₈-C₃₀ unsaturated fatty ester with an oxidant to form an epoxide of the C₈-C₃₀ unsaturated fatty acid or a C₈-C₃₀ unsaturated fatty ester, and contacting the epoxide with a compound selected from the group consisting of (HO)CO(CH₂)ₘSH, (HO)CO(CH₂)ₘP(O)(OR⁸)(R⁹), (HO)P(O)(OR¹⁹)₂, (HO)OP(O)(OH)₂ and (HO)COC(R¹⁰)═CH₂ to form the compound of Formula Ia.

In another aspect, a compound is provided where the compound is of Formula VIII or IX:

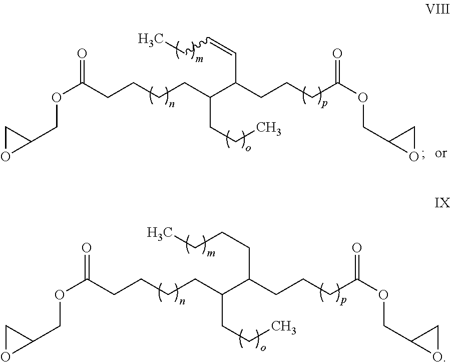

In the compounds of formula VIII or IX, each n, m, o and p is independently 1 to 12.

In another aspect, a compound is provided where the compound is of Formula IXa, IXb or IXc:

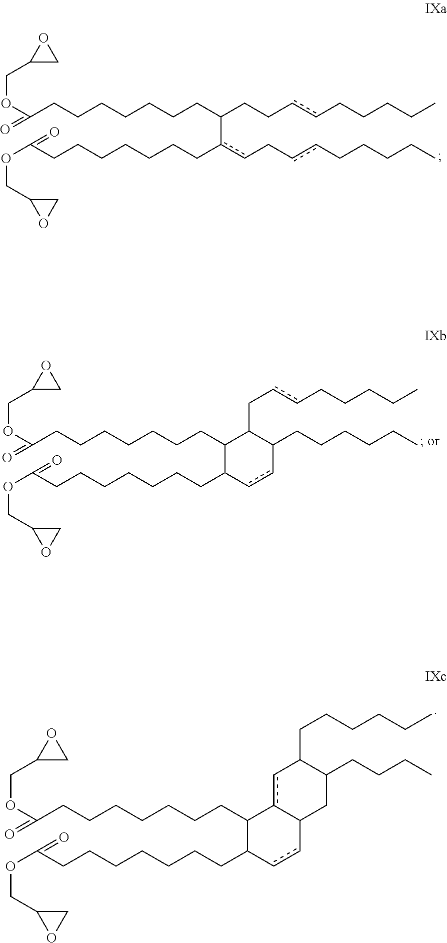

wherein each [symbol] is independently a single or double bond.

In another aspect, a compound is provided where the compound is of Formula IXd:

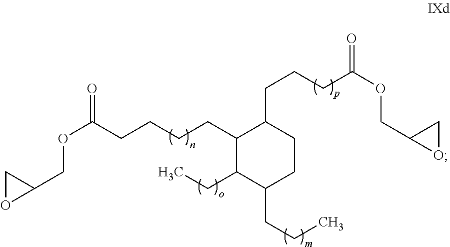

wherein each n, m, o and p is independently an integer from 1 to 12.

In another aspect, a compound is provided where the compound is of Formula X or Xa:

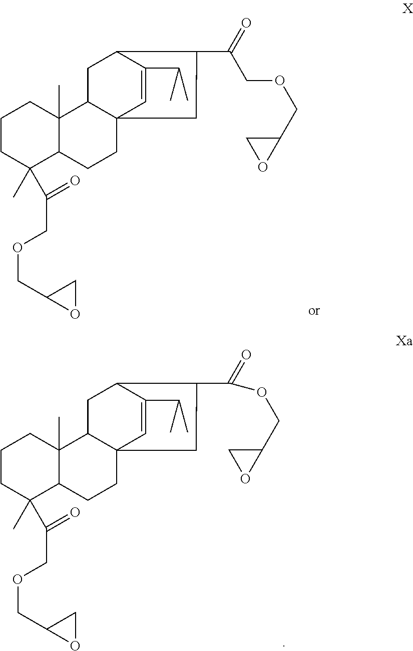 [SMILES: CC(C)C1=CC23CCC4C(C)(C(=O)COCC5CO5)CCCC4(C)C2CC1C(C(=O)COCC1CO1)C3 ; CC(C)C1=CC23CCC4C(C)(C(=O)COCC5CO5)CCCC4(C)C2CC1C(C(=O)OCC1CO1)C3]

In another aspect, a compound is provided, where the compound is of Formula XI:

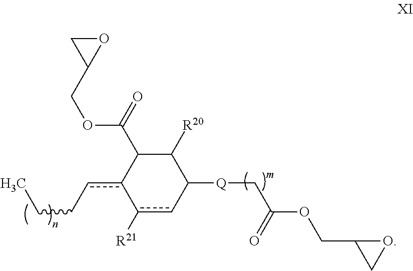

In Formula XI, R²⁰ is H or

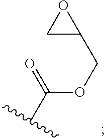 [SMILES: *C(=O)OCC1CO1]

### R²¹ is H or

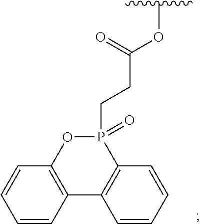 [SMILES: *OC(=O)CCP1(=O)Oc2ccccc2-c2ccccc21]

Q is a bond or —CH═CH—; each n and m is independently an integer from 1 to 12; and each [symbol] is independently a single or double bond.

In another aspect, a co-polymer is provided, where the co-polymer includes a polymerization product of a polymerizable monomer with any one of the compounds of Formula I-XI described herein. The terms “polymerizable monomer” and “polymerizable group” are used interchangeably herein.

In another aspect, composition is provided where the composition includes any one of the copolymers described herein, and an additive selected from the group consisting of a photoinitiator, light stabilizer, curing accelerator, dye, pigment, devolatilizer, levelling agent, and combinations thereof.

In another aspect, an article is provided where the article includes any of the compounds of Formula I-XI described herein or co-polymers described herein.

In another aspect, an epoxy resin is provided where the epoxy resin includes a reaction product of any of the compounds of Formula I-XI described herein, or any combination of two or more thereof, and a curing agent. In some embodiments, the curing agent is nadic methyl anhydride.

In another aspect, a process for preparing an epoxy resin is provided where the process includes: mixing any of the compounds of Formulae I-XI described herein or a combination thereof, with a curing agent to form the epoxy resin.

### BRIEF DESCRIPTION OF THE FIGURES

FIG. 1 shows ¹H NMR spectra of soybean oil and acrylated soybean oil (ASO) (entries 6 and 7, Table 2).

FIG. 2 shows the ¹³C NMR spectrum of ASO and the assignments of chemical shifts to individual carbons.

FIGS. 3A and 3B depict the storage modulus (a) and tan δ (b) versus temperature for cured unsaturated polyester samples with different ASO.

FIG. 4 depicts selected curves of load versus extension during bending test for the cured unsaturated polyester samples with different ASO.

FIG. 5 depicts ¹H-NMR spectra of APA and DGEAPA.

FIG. 6 depicts ¹H-NMR spectra of DA and DGEDA.

FIG. 7 depicts FT-IR spectra of DA, DGEDA, APA and DGEAPA.

FIG. 8 depicts DSC thermograms of curing of DGEAPA (a) and DGEDA (b) with NMA; α as a function of temperature for the DGEAPA/NMA system (c) and DGEDA/NMA system (d) at various heating rates.

FIG. 9 depicts plots of ln φ against 1/Tᵢ at different α for the calculation of activation energy.

FIG. 10 depicts the activation energy of curing of DGEAPA and DGEDA at different conversion (α).

FIG. 11 depicts the storage modulus (E′) and Tan δ of the cured epoxies with different DGEAPA/DGEDA ratios.

FIG. 12 depicts the flexural load-deflection curves of cured epoxies with different DGEAPA/DGEDA weight ratios.

FIG. 13 depicts TGA curves of cured epoxies under nitrogen environment. Curve labels (a-f) are the same as those in Table 4.

FIG. 14 depicts ¹H-NMR spectra of AME, C21DA and DGEC21 isomers.

FIG. 15a depicts ¹H-NMR spectra of FME, C22TA and TGEC22 isomers.

FIG. 15b depicts ¹H-NMR spectra of C21DA and C22TA isomers.

FIG. 15c depicts ¹H-NMR spectra of DGEC21 and TGEC22 isomers.

FIG. 15d depicts ¹³C-NMR spectra of DGEC21 and TGEC22 isomers.

FIG. 16 depicts the viscosity of prepared epoxies relative to commercial epoxy diluent DER353.

FIG. 17 depicts typical DSC thermograms of the epoxy/anhydride system at 2° C./min.

FIG. 18 depicts plots of 1/(Tp) versus ln(φ).

FIG. 19 depicts the temperature dependence of loss factor (tan δ) and storage modulus (G′) of thermosets formulated with DGEC21/NMA, TGEC22/NMA, and ESO/NMA.

FIG. 20 depicts representative load-deflection curves for several cured epoxies.

FIG. 21 depicts TGA results of cured resins.

### DETAILED DESCRIPTION

The illustrative embodiments described herein and in the claims are not meant to be limiting. Other embodiments may be utilized, and other changes may be made, without departing from the spirit or scope of the subject matter presented here. The present technology is also illustrated by the examples herein, which should not be construed as limiting in any way.

TABLE 1
Abbreviations Used in the Specification

| Abbreviation | Term |
|---|---|
| AA | Acrylic acid |
| ADH | Adipic dihydrazide |
| AME | Acrylo-methyl eleostearate |
| APA | Acrylopimaric acid |
| ASO | Acrylated soybean oil |
| BPO | Benzoyl peroxide |
| C21DA | C21 Dicarboxyl acid |
| C22TA | C22 Tricarboxyl acid |
| DA | A Mixture of C36 aliphatic |
| | diacids |
| DAAM | Diacetone acrylamide |
| DER332 | D.E.R. ® 332 Liquid Epoxy |
| | Resin No. 296, Bisphenol-A |
| | (Dow Chemical Company) |
| DGEAPA | Diglycidyl ester of |
| | acrylopimaric acid |
| DGEC21 | The Compound of Formula IV |
| DGEDA | Diglycidyl ester of dimer acid |
| DMA | Dynamic mechanical analysis |
| DMSO | Dimethyl sulfoxide |
| DPMA | Di(propylene glycol) methyl ether acetate |
| DSC | Differential scanning analysis |
| ESO | Epoxidized soybean oil |
| FME | Fumaric-methyl eleostearate |
| MOE | Elasticity modulus |
| NMA | Nadic methyl anhydride |
| PCDI | Polycarbodiimide |
| SO | Soybean oil |
| TGA | Thermogravimetric analysis |
| TGEC22 | The compound of Formula V |

As used herein, the following definitions of terms shall apply unless otherwise indicated.

In general, “substituted” refers to a group, as defined below (for example, an alkyl or aryl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (for example, F, Cl, Br, and I); hydroxyls; alkoxy, alkenoxy, alkynoxy, aryloxy, aralkyloxy, carbonyls(oxo), carboxyls, esters, urethanes, thiols, sulfides, sulfoxides, sulfones, sulfonyls, sulfonamides, amines, isocyanates, isothiocyanates, cyanates, thiocyanates, nitro groups, nitriles (for example, CN), and the like.

Alkyl groups include straight chain and branched alkyl groups having from 1 to 20 carbon atoms or, in some embodiments, from 1 to 12, 1 to 8, 1 to 6, or 1 to 4 carbon atoms. Alkyl groups further include cycloalkyl groups. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above. Where the term haloalkyl is used, the alkyl group is substituted with one or more halogen atoms.

Alkenyl groups include straight and branched chain and cycloalkyl groups as defined above, except that at least one double bond exists between two carbon atoms. Thus, alkenyl groups have from 2 to about 20 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 20 carbon atoms, 5 to 20 carbon atoms, 5 to 10 carbon atoms, or even 5, 6, 7, or 8 carbon atoms. Examples include, but are not limited to vinyl, allyl, CH═CH(CH₃), CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

Ester groups have the structure —OC(O)R^{A}, where A is an alkyl, alkenyl, alkynyl; or —OC(O)R^{A}, or R^{A}OC(O)R^{B}—, where A is alkyl, alkenyl, or alkynyl; and B is alkylenyl, alkenylenyl, or arylenyl.

The present disclosure is not meant to be limiting in terms of regioselectivity and/or olefin geometry. In particular, any possible regioselectivity that may be obtained from functionalizing sites of unsaturation are contemplated herein. Furthermore, the present disclosure is not intended to be limited to any particular olefin geometry. That is, both geometries of an olefin (for example, both E- and Z-isomers) may be functionalized in the disclosed compounds.

Alkynyl groups include straight and branched chain alkyl groups, except that at least one triple bond exists between two carbon atoms. Thus, alkynyl groups have from 2 to about 20 carbon atoms, and typically from 2 to 12 carbons or, in some embodiments, from 2 to 8, 2 to 6, or 2 to 4 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃), among others. Representative substituted alkynyl groups may be mono-substituted or substituted more than once, such as, but not limited to, mono-, di- or tri-substituted with substituents such as those listed above.

Aryl, or arene, groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (for example, indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

As used herein, the groups such as alkylenyl, alkenylenyl, arylenyl, aralkylenyl, refer to groups having two points of attachment. An alkylenyl, refers to an alkyl group having two points of attachment. For example, alkylenyl groups may include, but are not limited to methylene (—CH₂—), butylene (—CH₂CH₂CH₂CH₂—; —CH₂CH(CH₃)CH₂—; —CH(CH₃CH₂)CH₂—), and the like for other alkyl-based groups. An alkenylenyl, refers to an alkenyl group having two points of attachment. An arylenyl is an aryl group having two points of attachment. For example, one such group is a —C₆H₄— group. An aralkylenyl group is an aryl group with an alkylene group. For example, one such group is —C₆H₄CH₂—. The meanings of the other groups are similarly intended.

“Alkoxy” refers to the group —O-alkyl wherein alkyl is defined herein. Alkoxy includes, by way of example, methoxy, ethoxy, n-propoxy, isopropoxy, n-butoxy, t-butoxy, sec-butoxy, and n-pentoxy.

In general, compounds and co-polymers are provided that are suitable for numerous applications, such as epoxy resins, curing agents, flame retardants, UV curable agents, and the like.

### One-Step Derivatization of Unsaturated Fatty Acids and Fatty Esters

Provided herein are acrylated derivatives of fatty acids and fatty esters, such as acrylated soybean oil, that can be prepared in an one-step reaction by mixing acrylic acid and soybean oil under the catalysis of, for example, BF₃.Et₂O. See, for example, Scheme 1. In some embodiments, conversion of the double bonds of soybean oil increases with increases in acrylic acid and catalyst concentrations. Reaction time can also have a significant influence on the double bond conversion and product yield, where prolonged reaction times tend to increase the quantity of polymerized side products. Also provided herein is a simple and effective one-step synthetic process for making derivatized (for example, acrylated, acylated, phosphorylated and so on) fatty esters and acids.

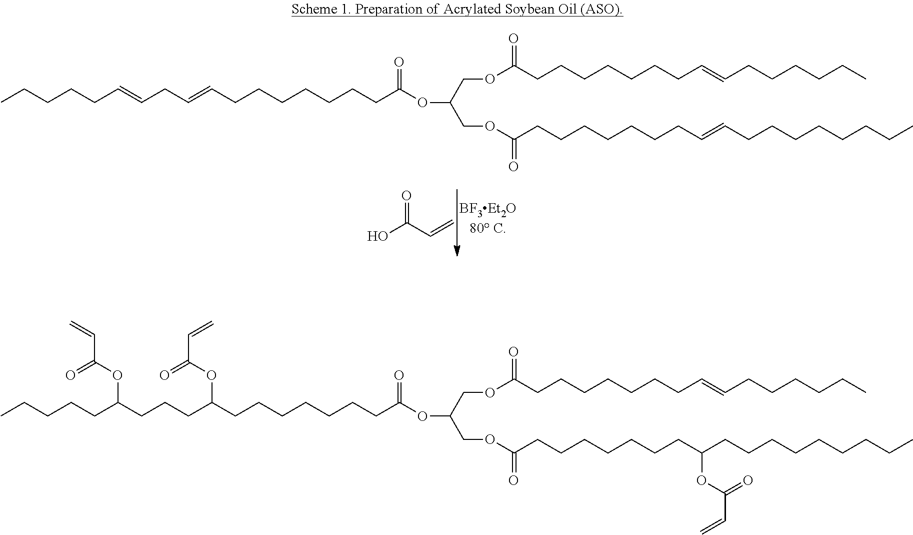

As described in more detail below, such acrylated derivatives of fatty acids and fatty esters may subsequently be co-polymerized with one or more polymerizable monomers, such as but not limited to styrene, to produce co-polymers suitable as epoxy resins, curing agents, flame retardants, UV curable agents, and the like. See for example Scheme 2. The co-polymers described herein may further include, for example, additives which are customary in the coatings industry, in the amounts customary for those additives: they include photoinitiators, light stabilizers, curing accelerators, dyes, pigments, for example, titanium dioxide pigment, devolatilizers, or levelling agents. Suitable additives, such as photoinitiators, are known to the person skilled in the art and some are also available commercially. The additive content may be, for example, from about 0.1 wt % to 25 wt %.

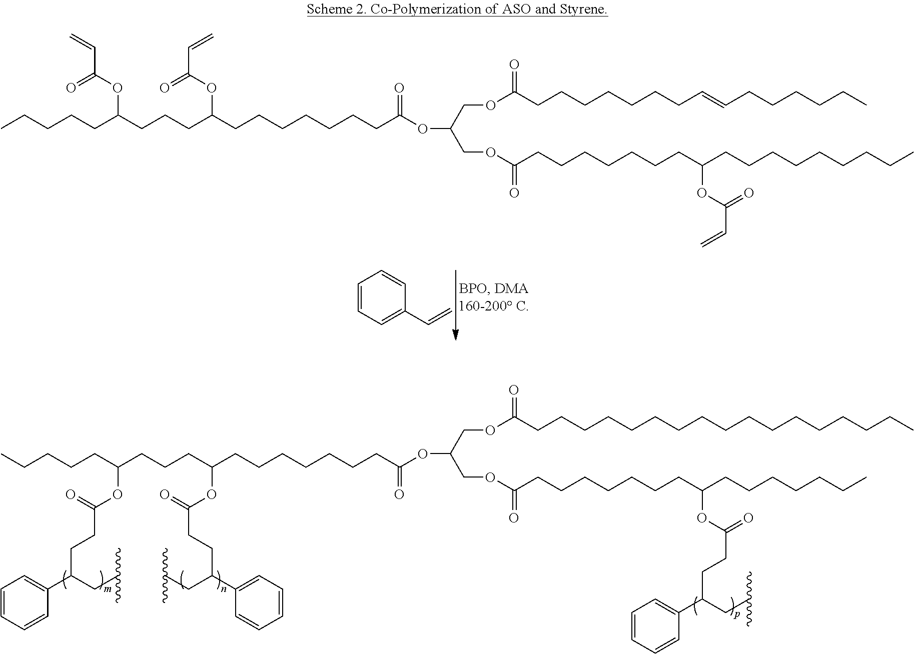

In one embodiment, a compound of Formula I is provided:

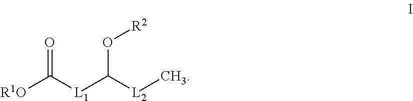

In Formula I, R¹ is H, alkyl or

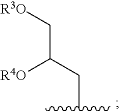

R³ and R⁴ are independently

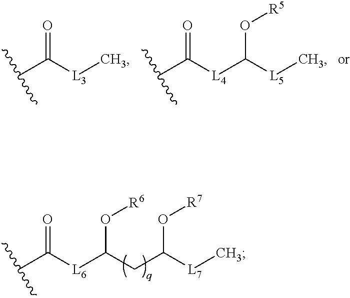

R², R⁵, R⁶ and R⁷ are independently CO(CH₂)ₘSH, CO(CH₂)ₘP(O)(OR⁸)(R⁹), P(O)(OR¹⁹)₂, P(O)(OH)₂, COC(R¹⁰)═CHR¹⁹ or COC(R¹⁰)═CH₂;
R⁸ is H, alkyl, or aryl;
R⁹ is H, alkyl, or aryl;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene or C₂-C₂₂ alkenylene;
m is 1 to 6; and
q is 1 to 6.

In some embodiments, where R⁸ and R⁹ are each an aryl, R⁸ and R⁹ can be joined together by a single bond.

In some embodiments, R¹ is H. In some embodiments, R¹ is alkyl. In some embodiments, R¹ is

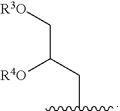

In some embodiments, R³ is

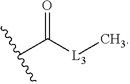

In some embodiments, R³ is

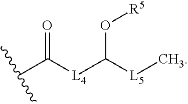

In some embodiments, R³ is

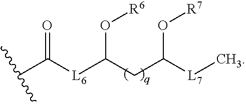

In some embodiments, R⁴ is

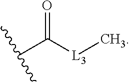

In some embodiments, R⁴ is

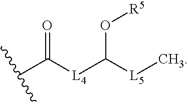

In some embodiments, R⁴ is

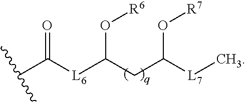

In some embodiments, R³ and R⁴ are the same. In some embodiments, R³ and R⁴ are different.

In some embodiments, R² is CO(CH₂)ₘSH. In some embodiments, R² is CO(CH₂)ₘP(O)(OR⁸)(R⁹). In some embodiments, R² is P(O)(OH)₂. In some embodiments, R² is P(O)(OR¹⁹)₂. In some embodiments, R² is COC(R¹⁰)═CH₂.

In some embodiments, R⁵ is CO(CH₂)ₘSH. In some embodiments, R⁵ is CO(CH₂)ₘP(O)(OR⁸)(R⁹). In some embodiments, R⁵ is P(O)(OH)₂. In some embodiments, R⁵ is P(O)(OR¹⁹)₂. In some embodiments, R⁵ is COC(R¹⁰)═CH₂.

In some embodiments, R⁶ is CO(CH₂)ₘSH. In some embodiments, R⁶ is CO(CH₂)ₘP(O)(OR⁸)(R⁹). In some embodiments, R⁶ is P(O)(OH)₂. In some embodiments, R⁶ is P(O)(OR¹⁹)₂. In some embodiments, R⁶ is COC(R¹⁰)═CH₂.

In some embodiments, R⁷ is CO(CH₂)ₘSH. In some embodiments, R⁷ is CO(CH₂)ₘP(O)(OR⁸)(R⁹). In some embodiments, R⁷ is P(O)(OH)₂. In some embodiments, R⁷ is P(O)(OR¹⁹)₂. In some embodiments, R⁷ is COC(R¹⁰)═CH₂.

In some embodiments, R², R⁵, R⁶ and R⁷ are the same. In some embodiments, R², R⁵, R⁶ and R⁷ are different.

In some embodiments, R⁸ is H. In some embodiments, R⁸ is alkyl. In some embodiments, R⁸ is aryl.

In some embodiments, R⁹ is H. In some embodiments, R⁹ is alkyl. In some embodiments, R⁹ is aryl.

In some embodiments, R⁸ and R⁹ are the same. In some embodiments, R⁸ and R⁹ are different.

In some embodiments, R⁸ and R⁹ are

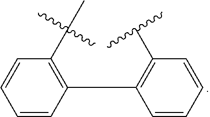 [SMILES: *c1ccccc1-c1ccccc1*]

In some embodiments, R¹⁰ is H. In some embodiments, R¹⁰ is halo. In some embodiments, R¹⁰ is alkyl. In some embodiments, R¹⁰ is alkenyl. In some embodiments, R¹⁰ is alkynyl. In some embodiments, R¹⁰ is alkoxy. In some embodiments, R¹⁰ is ester. In some embodiments, R¹⁰ is CN.

In some embodiments, R¹⁹ is alkyl. In some embodiments, R¹⁹ is C₁-C₆ alkyl, such as methyl, ethyl, propyl or butyl. In some embodiments, R¹⁹ is aryl. For example, R¹⁹ may be phenyl. In some embodiments, R¹⁹ is substituted phenyl.

L₁, L₂, L₃, L₄, L₅, L₆ and L₇ are independently C₁-C₂₂ alkylene or C₂-C₂₂ alkenylene in the compounds described herein, such that any combination of L groups does not exceed the number of carbons in the fatty acids or fatty ester described herein.

In some embodiments, L₁, L₂, L₃, L₄, L₅, L₆ and L₇ are independently C₁-C₂₂ alkylene. In some embodiments, L₁, L₂, L₃, L₄, L₅, L₆ and L₇ are independently C₁-C₁₂ alkylene. In some embodiments, L₁, L₂, L₃, L₄, L₅, L₆ and L₇ are independently C₁-C₈ alkylene. In some embodiments, L₁, L₂, L₃, L₄, L₅, L₆ and L₇ are independently C₁-C₆ alkylene. In some embodiments, L₁, L₂, L₃, L₄, L₅, L₆ and L₇ are independently C₁-C₄ alkylene.

In some embodiments, L₁, L₂, L₃, L₄, L₅, L₆ and L₇ are independently C₂-C₂₂ alkenylene. In some embodiments, L₁, L₂, L₃, L₄, L₅, L₆ and L₇ are independently C₂-C₁₂ alkenylene. In some embodiments, L₁, L₂, L₃, L₄, L₅, L₆ and L₇ are independently C₂-C₈ alkenylene. In some embodiments, L₁, L₂, L₃, L₄, L₅, L₆ and L₇ are independently C₂-C₄ alkenylene.

In some embodiments, m is 1, 2, 3, 4, 5, or 6. In some embodiments, q is 1, 2, 3, 4, 5, or 6.

In another embodiment, a compound of Formula II is provided:

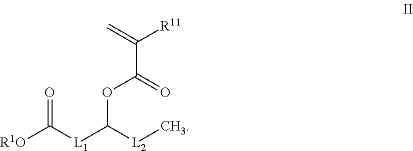

In Formula II, R¹ is H, alkyl, or

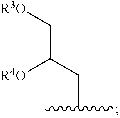

R³ and R⁴ are independently

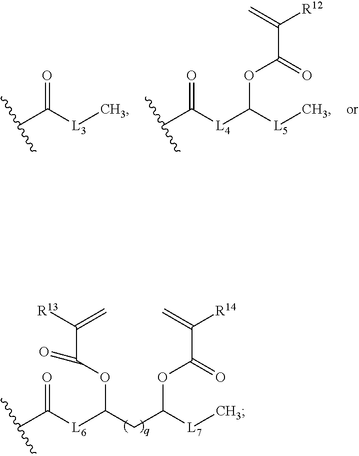

R¹¹, R¹², R¹³ and R¹⁴ are independently H, halo, alkyl, alkenyl, alkynyl, alkoxy, ester or CN; and
q is 1 to 6.

In some embodiments, R¹ is H. In some embodiments, R¹ is alkyl. In some embodiments, R¹ is

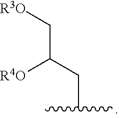

In some embodiments, R³ is

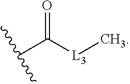

In some embodiments, R³ is

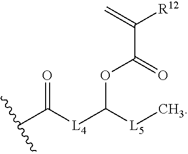

In some embodiments, R³ is

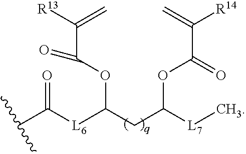

In some embodiments, R⁴ is

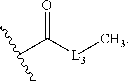

In some embodiments, R⁴ is

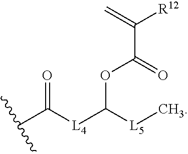

In some embodiments, R⁴ is

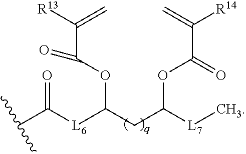

In some embodiments, R³ and R⁴ are the same. In some embodiments, R³ and R⁴ are different.

In some embodiments, R¹¹ is H. In some embodiments, R¹¹ is halo. In some embodiments, R¹¹ is alkyl. In some embodiments, R¹¹ is alkenyl. In some embodiments, R¹¹ is alkynyl. In some embodiments, R¹¹ is alkoxy. In some embodiments, R¹¹ is ester. In some embodiments, R¹¹ is CN.

In some embodiments, R¹² is H. In some embodiments, R¹² is halo. In some embodiments, R¹² is alkyl. In some embodiments, R¹² is alkenyl. In some embodiments, R¹² is alkynyl. In some embodiments, R¹² is alkoxy. In some embodiments, R¹² is ester. In some embodiments, R¹² is CN.

In some embodiments, R¹³ is H. In some embodiments, R¹³ is halo. In some embodiments, R¹³ is alkyl. In some embodiments, R¹³ is alkenyl. In some embodiments, R¹³ is alkynyl. In some embodiments, R¹³ is alkoxy. In some embodiments, R¹³ is ester. In some embodiments, R¹³ is CN.

In some embodiments, R¹⁴ is H. In some embodiments, R¹⁴ is halo. In some embodiments, R¹⁴ is alkyl. In some embodiments, R¹⁴ is alkenyl. In some embodiments, R¹⁴ is alkynyl. In some embodiments, R¹⁴ is alkoxy. In some embodiments, R¹⁴ is ester. In some embodiments, R¹⁴ is CN.

In some embodiments, R¹¹, R¹², R¹³ and R¹⁴ are the same. In some embodiments, R¹¹, R¹², R¹³ and R¹⁴ are different.

In some embodiments, L₁, L₂, L₃, L₄, L₅, L₆ and L₇ are independently C₁-C₂₂ alkylene. In some embodiments, L₁, L₂, L₃, L₄, L₅, L₆ and L₇ are independently C₁-C₁₂ alkylene. In some embodiments, L₁, L₂, L₃, L₄, L₅, L₆ and L₇ are independently C₁-C₈ alkylene. In some embodiments, L₁, L₂, L₃, L₄, L₅, L₆ and L₇ are independently C₁-C₆ alkylene. In some embodiments, L₁, L₂, L₃, L₄, L₅, L₆ and L₇ are independently C₁-C₄ alkylene.

In some embodiments, L₁, L₂, L₃, L₄, L₅, L₆ and L₇ are independently C₂-C₂₂ alkenylene. In some embodiments, L₁, L₂, L₃, L₄, L₅, L₆ and L₇ are independently C₂-C₁₂ alkenylene. In some embodiments, L₁, L₂, L₃, L₄, L₅, L₆ and L₇ are independently C₂-C₈ alkenylene. In some embodiments, L₁, L₂, L₃, L₄, L₅, L₆ and L₇ are independently C₂-C₄ alkenylene.

In some embodiments, m is 1, 2, 3, 4, 5, or 6. In some embodiments, q is 1, 2, 3, 4, 5, or 6.

In some embodiments, the compound is of Formula IIa, IIb, IIc or IId:

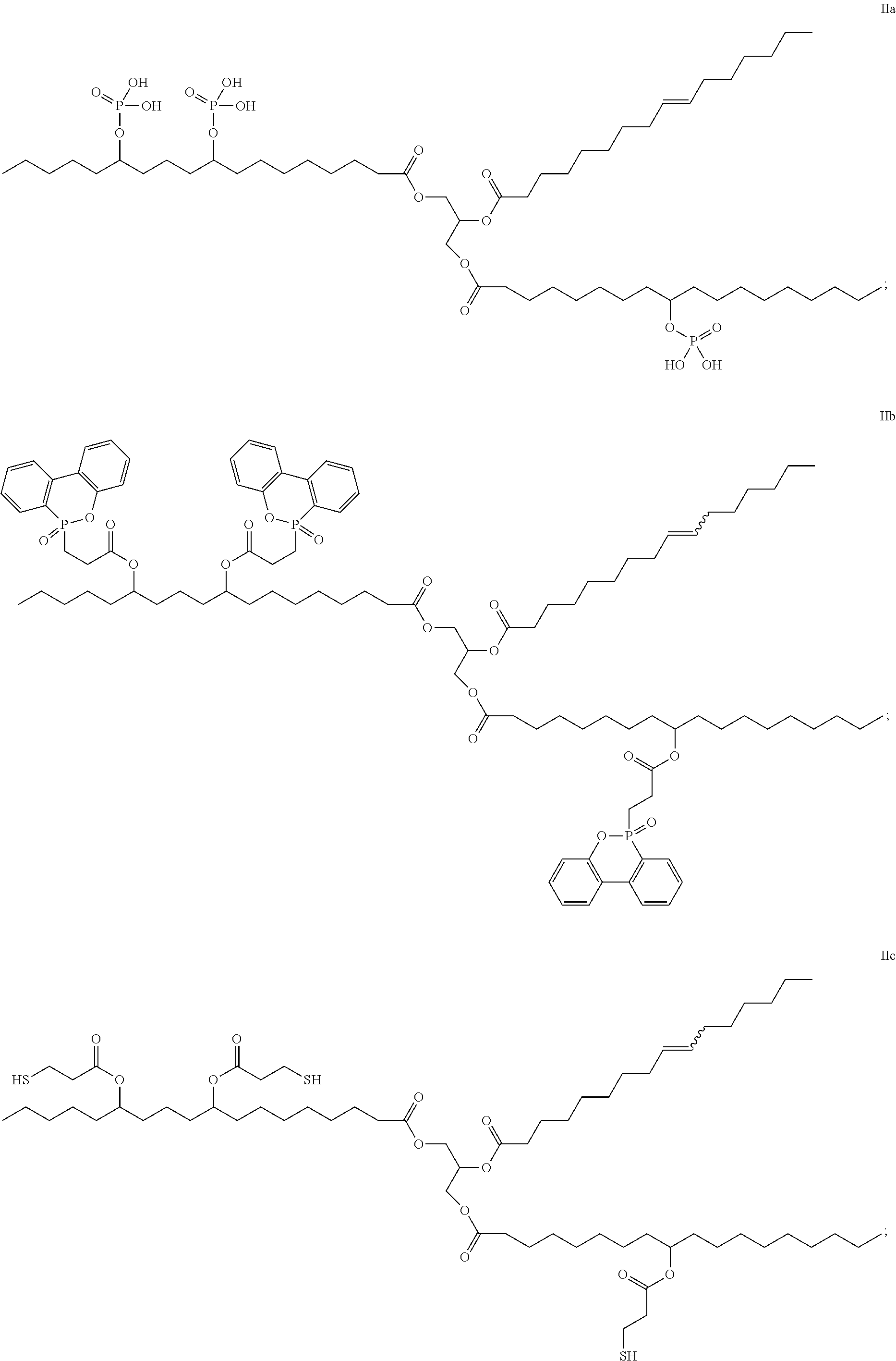

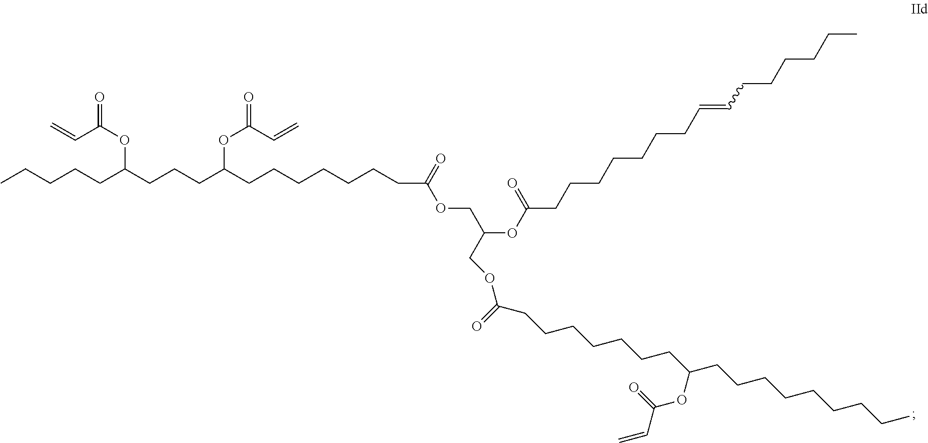 [SMILES: C=CC(=O)OC(CCCCCCCCC)CCCCCCCC(=O)OCC(COC(=O)CCCCCCCC(CCCC(CCCCC)OC(=O)C=C)OC(=O)C=C)OC(=O)CCCCCCCC=CCCCCCC]

In another embodiment, a compound of Formula Ia is provided:

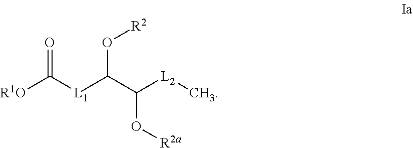

In Formula I, R¹ is H, alkyl or

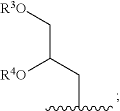

R³ and R⁴ are independently

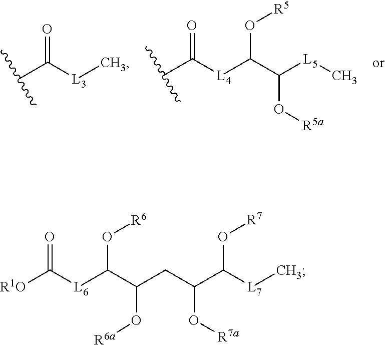

R², R⁵, R^{5a}, R⁶, R^{6a}, R⁷ and R^{7a} are independently CO(CH₂)ₘSH, CO(CH₂)ₘP(O)(OR⁸)(R⁹), P(O)(OR¹⁹)₂, P(O)(OH)₂, COC(R¹⁰)═CHR¹⁹, or COC(R¹⁰)═CH₂;
R⁸ is H, alkyl, or aryl;
R⁹ is H, alkyl, or aryl;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene; and
m is 1 to 6.

In some embodiments, where R⁸ and R⁹ are each an aryl, R⁸ and R⁹ can be joined together by a single bond.

In some embodiments, the compound of Formula Ia is a compound of Formula IIe:

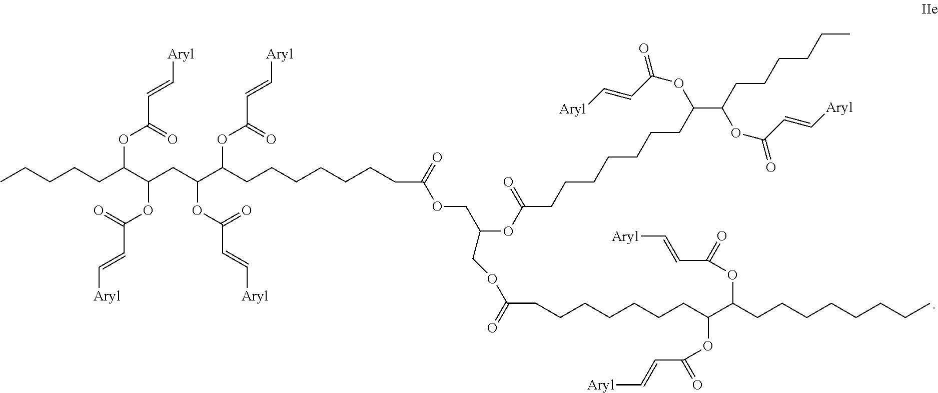

In some embodiments, the compound of Formula Ia is a compound of Formula IIf:

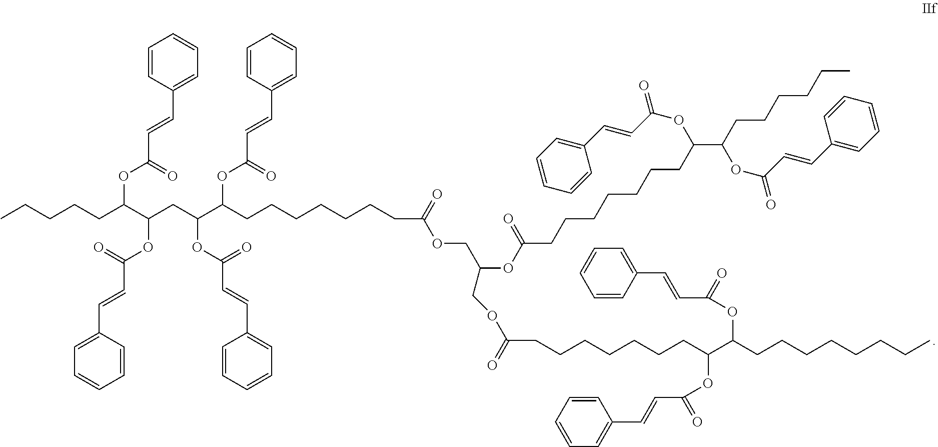 [SMILES: CCCCCCCCC(OC(=O)/C=C/c1ccccc1)C(CCCCCCCC(=O)OCC(COC(=O)CCCCCCCC(OC(=O)/C=C/c1ccccc1)C(CC(OC(=O)/C=C/c1ccccc1)C(CCCCC)OC(=O)/C=C/c1ccccc1)OC(=O)/C=C/c1ccccc1)OC(=O)CCCCCCCC(OC(=O)/C=C/c1ccccc1)C(CCCCCC)OC(=O)/C=C/c1ccccc1)OC(=O)/C=C/c1ccccc1]

In another aspect, a process is provided for preparing a compound of Formula Ia, the process comprising contacting a C₈-C₃₀ unsaturated fatty acid or a C₈-C₃₀ unsaturated fatty ester with an oxidant to form an epoxide of the C₈-C₃₀ unsaturated fatty acid or a C₈-C₃₀ unsaturated fatty ester, and contacting the epoxide with a compound selected from the group consisting of (HO)CO(CH₂)ₘSH, (HO)CO(CH₂)ₘP(O)(OR⁸)(R⁹), (HO)P(O)(OR¹⁹)₂, (HO)OP(O)(OH)₂ and (HO)COC(R¹⁰)═CH₂ to form the compound of Formula Ia.

In some embodiments, the process further comprises contacting the epoxide and the compound with a catalyst. For example, the catalyst may be any of the Lewis Acid catalysts described herein. In some embodiments, the oxidant is a peroxide such as hydrogen peroxide.

Schemes 3-5 depict the preparation of representative compounds as described herein. In some embodiments, the compounds are prepared by treating soybean oil, epoxidised soybean oil or acrylated epoxidised soybean oil with a catalyst (for example, BF₃-Et₂O) and the reagents shown in Scheme 3-5.

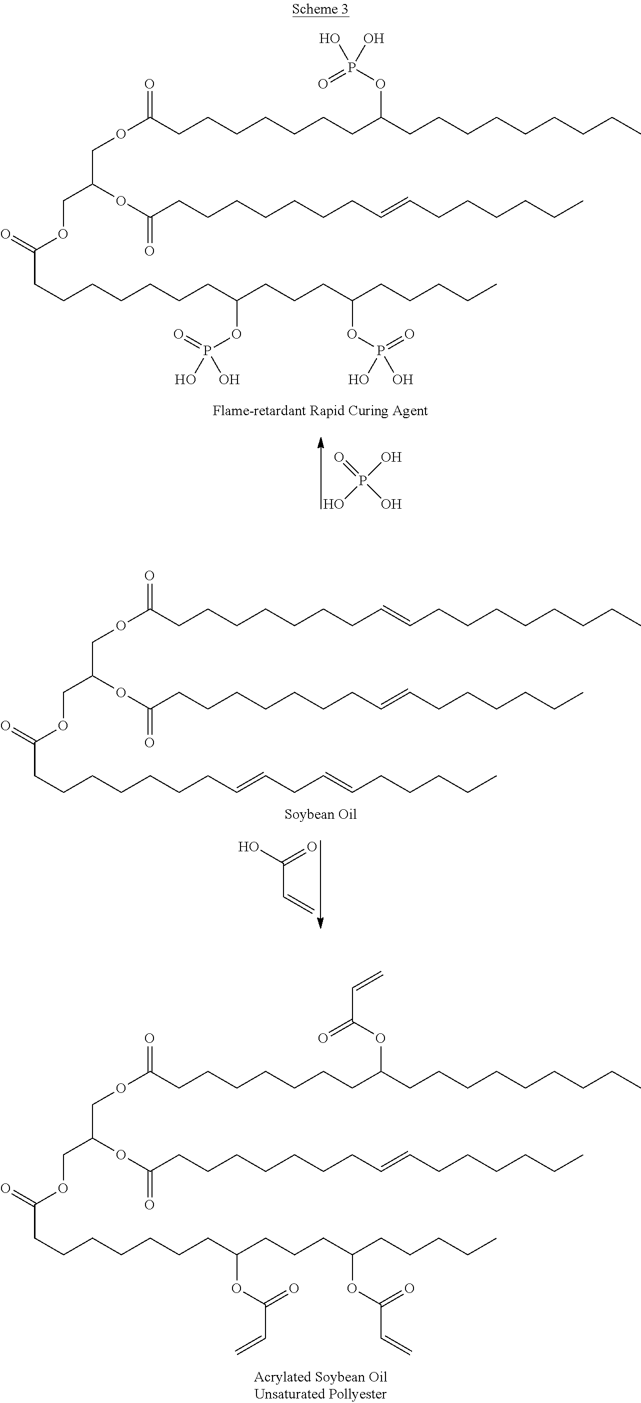

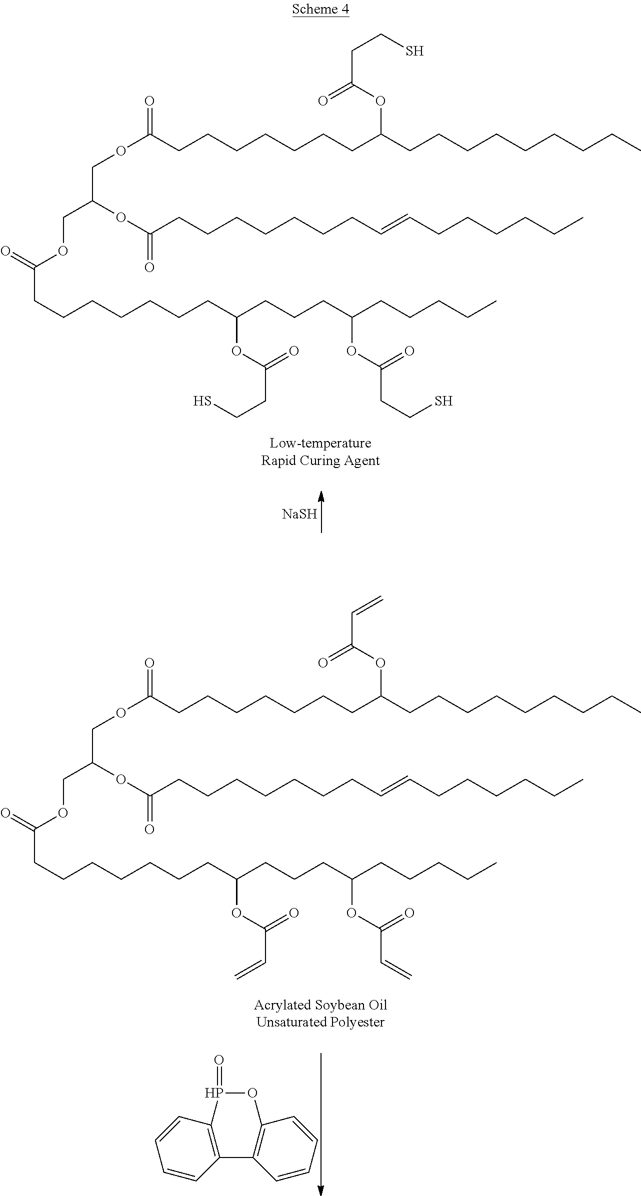

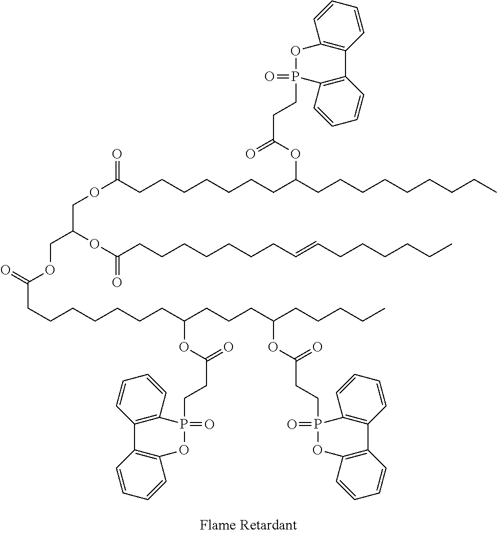 [SMILES: CCCCCC/C=C/CCCCCCCC(=O)OC(COC(=O)CCCCCCCC(CCCCCCCCC)OC(=O)CCP1(=O)Oc2ccccc2-c2ccccc21)COC(=O)CCCCCCCC(CCCC(CCCCC)OC(=O)CCP1(=O)Oc2ccccc2-c2ccccc21)OC(=O)CCP1(=O)Oc2ccccc2-c2ccccc21]

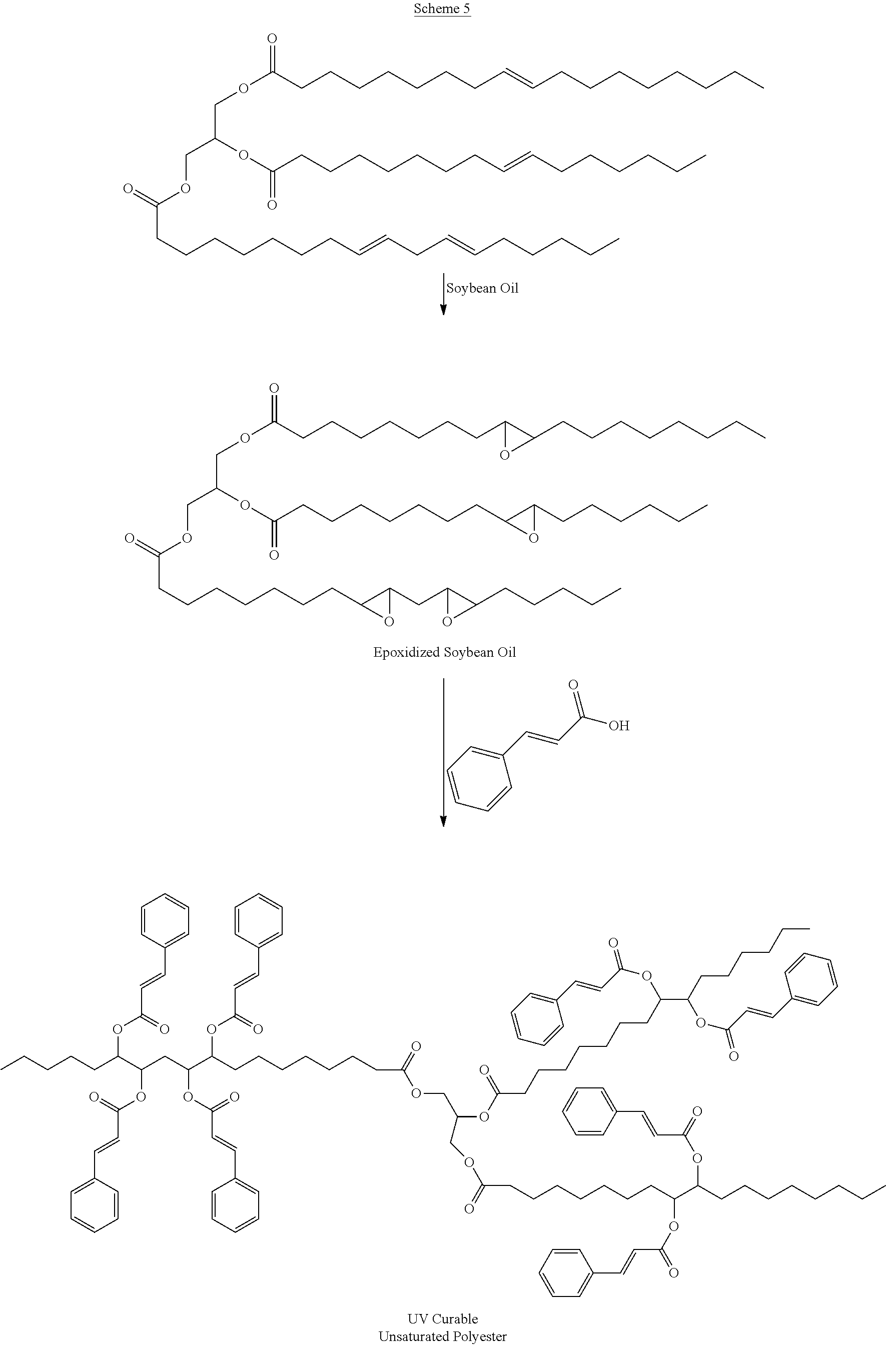

In some embodiments, the compound derives from a C₈-C₃₀ unsaturated fatty ester that is selected from the group consisting of a methyl ester, ethyl ester, propyl ester, butyl ester, monoglyceride, diglyceride, triglyceride and any combination of two or more thereof.

In some embodiments, the C₈-C₃₀ unsaturated fatty ester derive from a natural oil. Representative natural oils include lard, duck fat, chicken fat, butter, mutton fat, açai oil, almond oil, amaranth oil, amur cork tree fruit oil, apple seed oil, apricot oil, argan oil, artichoke oil, avocado oil, babassu oil, balanos oil, beech nut oil, ben oil, bitter gourd oil, black seed oil, blackcurrant seed oil, bladderpod oil, borage seed oil, borneo tallow nut oil, bottle gourd oil, brucea javanica oil, buffalo gourd oil, burdock oil, butternut squash seed oil, candlenut oil, canola/rapeseed oil, cape chestnut oil, carrot seed oil, cashew oil, castor oil, chaulmoogra oil, cocklebur oil, cocoa butter, coconut oil, cohune oil, colza oil, copaiba, coriander seed oil, corn oil, cottonseed oil, crambe oil, croton oil, cuphea oil, dammar oil, date seed oil, dika oil, egusi seed oil, evening primrose oil, false flax oil, flaxseed oil, grapefruit seed oil, hazelnut oil, hemp oil, honesty oil, honge oil, illipe butter, jajaba oil, jatropha oil, jojoba oil, kapok seed oil, kenaf seed oil, lallemantia oil, lemon oil, linseed oil, macadamia oil, mafura oil, mango oil, manila oil, meadowfoam seed oil, milk bush, mowrah butter, mustard oil, nahor oil, neem oil, nutmeg butter, ojon oil, okra seed oil, olive oil, orange oil, palm oil, papaya seed oil, pappyseed oil, paradise oil, peanut oil, pecan oil, pequi oil, perilla seed oil, persimmon seed oil, petroleum nut oil, pili nut oil, pine nut oil, pistachio oil, pomegranate seed oil, poppyseed oil, prune kernel oil, pumpkin seed oil, quinoa oil, radish oil, ramtil oil, rapeseed oil, rice bran oil, rose hip seed oil, royle oil, rubber seed oil, sacha inchi oil, safflower oil, salicornia oil, sapote oil, sea buckthorn oil, sea rocket seed oil, seje oil, sesame oil, shea butter, soybean oil, stillingia oil, sunflower oil, tall oil, tamanu or foraha oil, taramira oil, tea seed oil, thistle oil, tigernut oil, tobacco seed oil, tomato seed oil, tonka bean oil, tung oil, ucuhuba seed oil, vernonia oil, walnut oil, watermelon seed oil, wheat germ oil, and any combination of two or more thereof. In some embodiments, the C₈-C₃₀ unsaturated fatty ester derives from soybean oil.

In some embodiments, the unsaturated fatty ester is a C₈-C₃₀ unsaturated fatty ester that derives from a C₈-C₃₀ fatty acid. In some embodiments, the C₈-C₃₀ unsaturated fatty ester derives from a C₈-C₃₀ fatty acid selected from the group consisting of myristoleic acid, oleic acid, palmitoleic acid, (trans) vaccenic acid, hexadecatrienoic acid, linoleic acid, α-linolenic acid, β-linolenic acid, γ-linolenic acid, stearidonic acid, eicosatrienoic acid, eicosatetraenoic acid, eicosapentenoic acid, heneicosapentenoic acid, docosapentenoic acid, docosahexaenoic acid, tetracosapentenoic acid, tetracosahexaenoic acid, sapienic acid, elaidic acid, linoelaidic acid, α-eleostearic acid, β-eleostearic acid, arachidonic acid, erucic acid and combinations of any two or more thereof.

As noted, in another embodiment, a co-polymer is provided, where the co-polymer includes a polymerization product of a polymerizable monomer with any one of the unsaturated compounds described herein.

In some embodiments, the polymerizable monomer is a polymerizable group, PG¹, selected from the group consisting of isosorbide monoacrylyl, isosorbide diacrylyl, acrylyl, methacrylyl, epoxy, isocyano, styrenyl, vinyl, oxyvinyl, and a thiovinyl group.

In some embodiments, the co-polymer is of Formula III

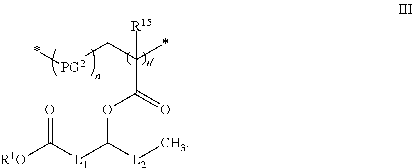

In Formula I, R¹ is H, alkyl, or

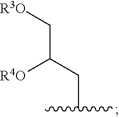

R³ and R⁴ are independently

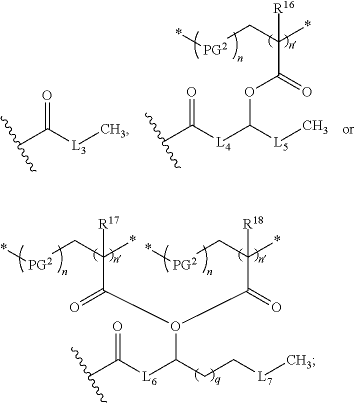

R¹⁵, R¹⁶, R¹⁷ and R¹⁸ are independently selected from the group consisting of H, halo, alkyl, alkenyl, alkynyl, alkoxy, ester and CN;
PG² is the polymerized from the polymerizable group PG¹;
each n and n′ is independently about 2 to about 100,000; and
q is 1 to 6.

In some embodiments, R¹ is H. In some embodiments, R¹ is alkyl. In some embodiments, R¹ is

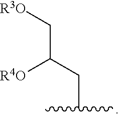

In some embodiments, R³ is

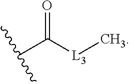

In some embodiments, R³ is

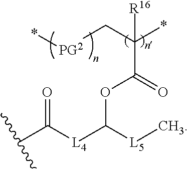

In some embodiments, R³ is

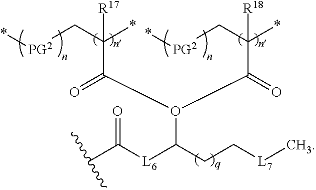

In some embodiments, R⁴ is

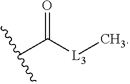

In some embodiments, R⁴ is

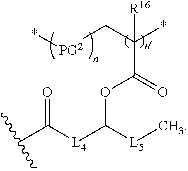

In some embodiments, R⁴ is

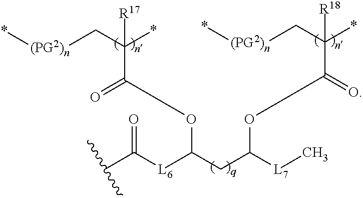

In some embodiments, R³ and R⁴ are the same. In some embodiments, R³ and R⁴ are different.

In some embodiments, R¹⁵ is H. In some embodiments, R¹⁵ is halo. In some embodiments, R¹⁵ is alkyl. In some embodiments, R¹⁵ is alkenyl. In some embodiments, R¹⁵ is alkynyl. In some embodiments, R¹⁵ is alkoxy. In some embodiments, R¹⁵ is ester. In some embodiments, R¹⁵ is CN.

In some embodiments, R¹⁶ is H. In some embodiments, R¹⁶ is halo. In some embodiments, R¹⁶ is alkyl. In some embodiments, R¹⁶ is alkenyl. In some embodiments, R¹⁶ is alkynyl. In some embodiments, R¹⁶ is alkoxy. In some embodiments, R¹⁶ is ester. In some embodiments, R¹⁶ is CN.

In some embodiments, R¹⁷ is H. In some embodiments, R¹⁷ is halo. In some embodiments, R¹⁷ is alkyl. In some embodiments, R¹⁷ is alkenyl. In some embodiments, R¹⁷ is alkynyl. In some embodiments, R¹⁷ is alkoxy. In some embodiments, R¹⁷ is ester. In some embodiments, R¹⁷ is CN.

In some embodiments, R¹⁸ is H. In some embodiments, R¹⁸ is halo. In some embodiments, R¹⁸ is alkyl. In some embodiments, R¹⁸ is alkenyl. In some embodiments, R¹⁸ is alkynyl. In some embodiments, R¹⁸ is alkoxy. In some embodiments, R¹⁸ is ester. In some embodiments, R¹⁸ is CN.

In some embodiments, R¹⁵, R¹⁶, R¹⁷ and R¹⁸ are the same. In some embodiments, R¹⁵, R¹⁶, R¹⁷ and R¹⁸ are different.

In some embodiments, L₁, L₂, L₃, L₄, L₅, L₆ and L₇ are independently C₁-C₂₂ alkylene. In some embodiments, L₁, L₂, L₃, L₄, L₅, L₆ and L₇ are independently C₁-C₁₂ alkylene. In some embodiments, L₁, L₂, L₃, L₄, L₅, L₆ and L₇ are independently C₁-C₈ alkylene. In some embodiments, L₁, L₂, L₃, L₄, L₅, L₆ and L₇ are independently C₁-C₆ alkylene. In some embodiments, L₁, L₂, L₃, L₄, L₅, L₆ and L₇ are independently C₁-C₄ alkylene.

In some embodiments, L₁, L₂, L₃, L₄, L₅, L₆ and L₇ are independently C₂-C₂₂ alkenylene. In some embodiments, L₁, L₂, L₃, L₄, L₅, L₆ and L₇ are independently C₂-C₁₂ alkenylene. In some embodiments, L₁, L₂, L₃, L₄, L₅, L₆ and L₇ are independently C₂-C₈ alkenylene. In some embodiments, L₁, L₂, L₃, L₄, L₅, L₆ and L₇ are independently C₂-C₄ alkenylene.

In some embodiments, m is 1, 2, 3, 4, 5, or 6. In some embodiments, q is 1, 2, 3, 4, 5, or 6.

In some embodiments, n is about 10 to about 100. In some embodiments, n is about 100 to about 1,000. In some embodiments, n is about 1,000 to about 10,000. In some embodiments, n is about 10,000 to about 100,000.

In some embodiments, n′ is about 10 to about 100. In some embodiments, n′ is about 100 to about 1,000. In some embodiments, n′ is about 1,000 to about 10,000. In some embodiments, n′ is about 10,000 to about 100,000.

In some embodiments, the polymerizable monomer (i.e., polymerizable group, PG¹ or PG², as the terms “polymerizable monomer” and “polymerizable group” are used interchangeably throughout) is a (meth)acrylic monomer. As used herein, the term (meth)acrylic monomer refers to acrylic or methacrylic acid, esters of acrylic or methacrylic acid, and salts, amides, and other suitable derivatives of acrylic or methacrylic acid, and mixtures thereof. Examples of suitable acrylic monomers for PG¹ or PG² include, without limitation, the following methacrylate esters:methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters for PG¹ or PG² include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate.

In some embodiments, the polymerizable monomer is a polymerizable group, PG¹, consisting of isosorbide monoacrylyl, isosorbide diacrylyl, acrylyl, methacrylyl, epoxy, isocyano, styrenyl, vinyl, oxyvinyl, and a thiovinyl group.

In some embodiments, any of the co-polymers described herein have a weight average molecular weight of about 5,000 to about 2,000,000 g/mol, about 5,000 to about 500,000 g/mol, about 5,000 to about 100,000 g/mol or about 5,000 to about 50,000 g/mol.

In some embodiments, the compound from which the co-polymer is made derives from soybean oil.

In another embodiment, a process is provided for preparing a compound of Formula I, the process comprising:
mixing together a compound selected from the group consisting of (HO)CO(CH₂)ₘSH, (HO)CO(CH₂)ₘP(O)(OR⁸)(R⁹), (HO)P(O)(OR¹⁹)₂, (HO)OP(O)(OH)₂ and (HO)COC(R¹⁰)═CH₂;
a catalyst; and
a C₈-C₃₀ unsaturated fatty acid or a C₈-C₃₀ unsaturated fatty ester to form the compound of Formula I:

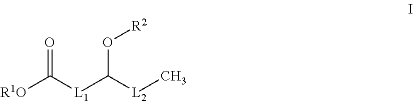

The compound, the catalyst, and the unsaturated fatty acid or the unsaturated fatty ester, will be referred to herein as a “mixture”.

In Formula I, R¹ is H, alkyl or

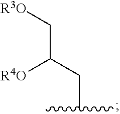

R³ and R⁴ are independently

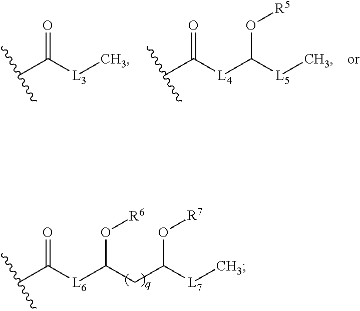

R², R⁵, R⁶ and R⁷ are independently CO(CH₂)ₘSH, CO(CH₂)ₘP(O)(OR⁸)(R⁹), P(O)(OR¹⁹)₂, P(O)(OH)₂, COC(R¹⁰)═CHR¹⁹ and COC(R¹⁰)═CH₂;
R⁸ is H, alkyl, or aryl;
R⁹ is H, alkyl, or aryl;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene or C₂-C₂₂ alkenylene;
m is 1 to 6; and
q is 1 to 6.

In an embodiment, where R⁸ and R⁹ are each an aryl, R⁸ and R⁹ can be joined together by a single bond.

In some embodiments of the process, R¹, R², R⁴, R⁵, R⁶, R⁷, R⁸, R⁹, R¹⁰, L₁, L₂, L₃, L₄, L₅, L₆, L₇, m and q are as described above.

In some embodiments of the above process, R¹, R², R⁴, R⁵, R⁶, R⁷, R⁸, R⁹, R¹⁰, L₁, L₂, L₃, L₄, L₅, L₆, L₇, m and q are as described above.

In some embodiments of the process, the compound of Formula I that is provided is a compound of Formula II:

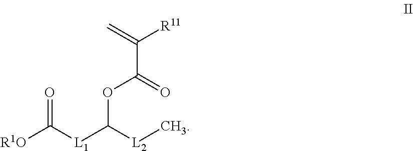

In Formula II, R¹ is H, alkyl, or

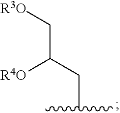

R³ and R⁴ are independently

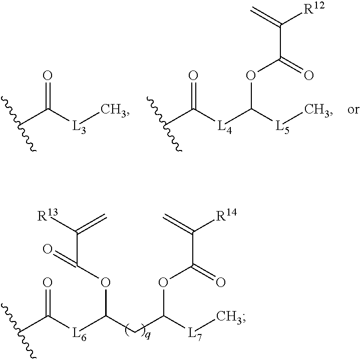

R¹¹, R¹², R¹³ and R¹⁴ are independently H, halo, alkyl, alkenyl, alkynyl, alkoxy, ester or CN; and
q is 1 to 6.

In some embodiments of the above process, R¹, R², R⁴, R¹¹, R¹², R¹³, R¹⁴, L₁, L₂, L₃, L₄, L₅, L₆, L₇, m and q are as described above.

The process disclosed herein may be used to directly functionalize one or more olefinic moieties in a C₈-C₃₀ unsaturated fatty ester or C₈-C₃₀ unsaturated fatty acid. Generally, one or more olefins of the C₈-C₃₀ unsaturated polyester or C₈-C₃₀ unsaturated fatty acid starting material are functionalized using the reagents disclosed herein.

In some embodiments, the compound of Formula I-IIf is formed by mixing together a (meth)acrylic monomer, the catalyst, and C₈-C₃₀ unsaturated fatty ester or C₈-C₃₀ unsaturated fatty acid, where the (meth)acrylic monomer is as described herein.

In some embodiments, the process further includes heating the mixture to a temperature of about 60° C. to about 180° C., for example, about 60° C., about 80° C., about 100° C., about 120° C., about 180° C., or a temperature between any two of these values. In some embodiments, the process includes heating the mixture to a temperature of about 80° C.

In some embodiments, heating is applied for about 1 hour to about 48 hours, for example, about 1 hour, 5 hours, 10 hours, 24 hours, 48 hours or a time span between any two of these values. A person of ordinary skill in the art will recognize that the progress of the reaction may be monitored by techniques known in the art (for example, thin-layer chromatography, nuclear magnetic resonance analysis, infrared spectroscopy, gas chromatography, mass spectrometry, and any combination of two or more thereof) and that the reaction may be carried out for the maximum time period, or it may be stopped when a sufficient amount of conversion has taken place (for example, more than 50% conversion, such as about 60%, 70%, 80%, or 90% conversion). The reaction may be stopped and the product purified using suitable purification methods, such as column chromatography, distillation (reduced pressure or atmospheric pressure), extraction (for example, washing with basic or acidic solutions and/or brine, and extracting with a suitable organic solvent), and any combination of two or more thereof.

A “catalyst” as used herein is a substance that accelerates the rate of a reaction (for example, 1-10 fold, 10-1,000 fold or more). Generally, less than one equivalent of a catalyst is sufficient to accelerate the rate of reaction of one equivalent of a reactant to a product. In some embodiments, the catalyst is a Lewis acid catalyst, i.e., a compound that is an electron-pair acceptor. In some embodiments, the Lewis acid catalyst is selected from the group consisting of boron trifluoride etherate (i.e., BF₃.OEt₂), boron trichloride, tris(pentafluorophenyl) borane, trimethylaluminum, aluminum bromide, aluminum chloride, titanium(IV) isopropoxide, indium(III) chloride, zirconium(IV) chloride, copper chloride, copper(I) iodide, copper(I) bromide, iron(III) bromide, iron(III) chloride, tin(IV) chloride, titanium(IV) chloride, niobium(V) chloride, antimony(III) chloride, silver hexafluoroantimonate(V), copper(II) trifluoromethanesulfonate, silver trifluoromethanesulfonate, indium(III) trifluoromethanesulfonate, lithium trifluoromethanesulfonate, scandium trifluoromethanesulfonate, ammonium cerium(IV) nitrate and any combination of two or more thereof. In some embodiments, the Lewis acid catalyst is BF₃.OEt₂.

In some embodiments, the catalyst is a protic acid catalyst, i.e., a compound that can donate a proton. In some embodiments, the catalyst is selected from the group consisting of hydrochloric acid, hydrobromic acid, hydroiodic acid, hypochlorous acid, chlorous acid, chloric acid, perchloric acid, sulfuric acid, fluorosulfuric acid, nitric acid, phosphoric acid, fluoroantimonic acid, fluoroboric acid, hexafluorophosphoric acid, chromic acid, boric acid, methanesulfonic acid, ethanesulfonic acid, benzenesulfonic acid, p-toluenesulfonic acid, trifluoromethanesulfonic acid, polystyrene sulfonic acid,

The amount of catalyst used in the disclosed process may range from about 0.2 equivalents (meaning the equivalent units with respect to 1 equivalent of the double bonds present in the polyester starting material) to about 5 equivalents; or from about 0.5 equivalents to about 1.5 equivalents; or from about 1 equivalent to about 1.4 equivalents.

The (meth)acrylic monomer, the catalyst, and C₈-C₃₀ unsaturated fatty ester or C₈-C₃₀ unsaturated fatty acid, may be mixed in a molar ratio of 1-50:0.1-5:1 ((meth)acrylic monomer:catalyst:unsaturated fatty ester or unsaturated fatty acid). In some embodiments, the molar ratio is 5-30:0.1-2:1, respectively. Generally, high catalyst concentrations (for example, at least 0.5 mole percent relative to C₈-C₃₀ unsaturated fatty ester or C₈-C₃₀ unsaturated fatty acid) and (meth)acrylic monomer concentrations (for example, at least 5 mole percent relative to C₈-C₃₀ unsaturated fatty ester or C₈-C₃₀ unsaturated fatty acid) increased product yield. In some embodiments, 0.01 to 0.5 mole percent of a polymerization inhibitor, such as hydroquinone or those discussed below, is added to the mixture. In some embodiments, 0.25 mole percent of a polymerization inhibitor is added to the mixture.

In some embodiments, the process further includes adding a polymerization inhibitor to the mixture. In some embodiments, the polymerization inhibitor is selected from the group consisting of tert-butylhydroquinone, 4-methoxyphenol, p-toluhydroquinone, 1,4-benzoquinone, hydroquinone, copper(I) chloride, iron(III) chloride and any combination of two or more thereof.

In some embodiments, the process is conducted in the absence of a solvent.

In some embodiments, the process further includes adding a solvent to the mixture. In some embodiments, the solvent is selected from the group consisting of toluene, xylene, chlorobenzene, nitrobenzene, dimethylformamide, dimethylsulfoxide, acetonitrile, dichloroethane, tetrachloroethane, butyl ether, 1,4-dioxane, ethybenzene, tetrachlorothylene, n-octane, iso-octane, cyclohexanone, methyl ethyl ketone and any combination of two or more thereof.

In some embodiments of the process, the C₈-C₃₀ unsaturated fatty ester is selected from the group consisting of a methyl ester, ethyl ester, propyl ester, butyl ester, monoglyceride, diglyceride, triglyceride and any combination of two or more thereof.

In some embodiments of the process, the C₈-C₃₀ unsaturated fatty ester derives from one or more natural oils. Representative natural oils include lard, duck fat, chicken fat, butter, mutton fat, açai oil, almond oil, amaranth oil, amur cork tree fruit oil, apple seed oil, apricot oil, argan oil, artichoke oil, avocado oil, babassu oil, balanos oil, beech nut oil, ben oil, bitter gourd oil, black seed oil, blackcurrant seed oil, bladderpod oil, borage seed oil, borneo tallow nut oil, bottle gourd oil, brucea javanica oil, buffalo gourd oil, burdock oil, butternut squash seed oil, candlenut oil, canola/rapeseed oil, cape chestnut oil, carrot seed oil, cashew oil, castor oil, chaulmoogra oil, cocklebur oil, cocoa butter, coconut oil, cohune oil, colza oil, copaiba, coriander seed oil, corn oil, cottonseed oil, crambe oil, croton oil, cuphea oil, dammar oil, date seed oil, dika oil, egusi seed oil, evening primrose oil, false flax oil, flaxseed oil, grapefruit seed oil, hazelnut oil, hemp oil, honesty oil, honge oil, illipe butter, jajaba oil, jatropha oil, jojoba oil, kapok seed oil, kenaf seed oil, lallemantia oil, lemon oil, linseed oil, macadamia oil, mafura oil, mango oil, manila oil, meadowfoam seed oil, milk bush, mowrah butter, mustard oil, nahor oil, neem oil, nutmeg butter, ojon oil, okra seed oil, olive oil, orange oil, palm oil, papaya seed oil, pappyseed oil, paradise oil, peanut oil, pecan oil, pequi oil, perilla seed oil, persimmon seed oil, petroleum nut oil, pili nut oil, pine nut oil, pistachio oil, pomegranate seed oil, poppyseed oil, prune kernel oil, pumpkin seed oil, quinoa oil, radish oil, ramtil oil, rapeseed oil, rice bran oil, rose hip seed oil, royle oil, rubber seed oil, sacha inchi oil, safflower oil, salicornia oil, sapote oil, sea buckthorn oil, sea rocket seed oil, seje oil, sesame oil, shea butter, soybean oil, stillingia oil, sunflower oil, tall oil, tamanu or foraha oil, taramira oil, tea seed oil, thistle oil, tigernut oil, tobacco seed oil, tomato seed oil, tonka bean oil, tung oil, ucuhuba seed oil, vernonia oil, walnut oil, watermelon seed oil, wheat germ oil, and any combination of two or more thereof. In some embodiments of the process, the unsaturated fatty ester is soybean oil.

In some embodiments of the process, the C₈-C₃₀ unsaturated fatty acid is selected from the group consisting of myristoleic acid, palmitoleic acid, sapienic acid, oleic acid, elaidic acid, vaccenic acid, linoleic acid, linoelaidic acid, α-linolenic acid, eleostearic acid, arachidonic acid, eicosapentaenoic acid, erucic acid, docosahexaenoic acid, ricinoleic acid, hexadecatrienoic acid, stearidonic acid, eicosatetraenoic acid, eicosapentaenoic acid, heneicosapentaenoic acid, docosapentaenoic acid, tetracosapentaenoic acid, tetracosahexaenoic acid, and any combination of two or more thereof.

As noted herein, the compounds of Formula I-IIf may be combined with a polymerizable moiety i.e., curing agent and, optionally, an initiator to form the co-polymers of Formula III. Crosslinking typically may occur between one or more terminal olefins; however, the olefin need not be limited to a terminal olefin. Suitable initiators include, but are not limited to 2,2′-azodi-(2,4-dimethylvaleronitrile); 2,2′-azobisisobutyronitrile (AIBN); 2,2′-azobis(2-methylbutyronitrile); 1,1′-azobis(cyclohexane-1-carbonitrile); tertiary butylperbenzoate; tert-amyl peroxy 2-ethylhexyl carbonate; 1,1-bis(tert-amylperoxy)cyclohexane, tert-amylperoxy-2-ethylhexanoate, tert-amylperoxyacetate, tert-butylperoxyacetate, tert-butylperoxybenzoate (TBPB), 2,5-di-(tert-butylperoxy)-2,5-dimethylhexane, di-tert-amyl peroxide (DTAP); di-tert-butylperoxide (DTBP); lauryl peroxide; dilauryl peroxide (DLP), succinic acid peroxide; or benzoyl peroxide. In some embodiments, the polymerization initiator includes 2,2′-azodi-(2,4-dimethylvaleronitrile); 2,2′-azobisisobutyronitrile (AIBN); or 2,2′-azobis(2-methylbutyronitrile). In other embodiments, the polymerization initiator includes di-tert-amyl peroxide (DTAP); di-tert-butylperoxide (DTBP); lauryl peroxide; succinic acid peroxide; or benzoyl peroxide.

Also provided is a Compound of Formula I-IIf prepared by any one of the processes described herein.

### Tung Oil-Derived Epoxides

Chemical feedstocks having shorter aliphatic chain or rigid moieties are generally sought to improve the stiffness of oil based epoxy materials. Such potentially useful feedstocks include C21 dicarboxyl acid (C21DA) and C22 tricarboxyl acid (C22TA), which have shorter aliphatic chains (21 or 22 carbons) and cyclic segments compared to plant oils. C21DA and C22TA are prepared from tung oil, which is a conjugated drying oil derived from the nuts of Aleurites fordiiz. Tung oil fatty acids contain about 85% eleostearic acid, which has three conjugated double bonds. Diels-Alder reactions tends to proceed easily with eleostearic acid, without catalysts. As a result, dienophiles react readily with tung oil fatty acids at lower temperatures compared with both tall oil fatty acids or dehydrated castor oil fatty acids. Additionally, because there are 85% eleostearic acids in tung oil fatty acids, reaction yields are generally high.

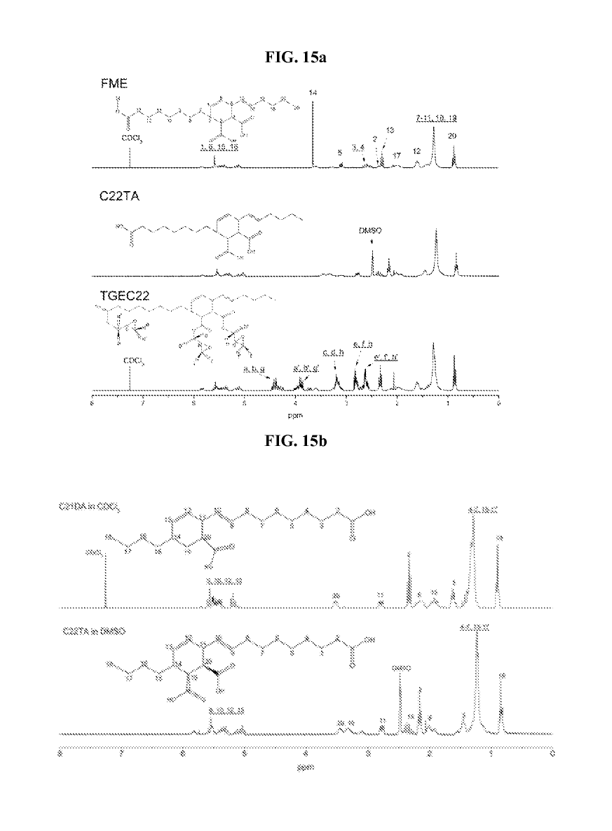

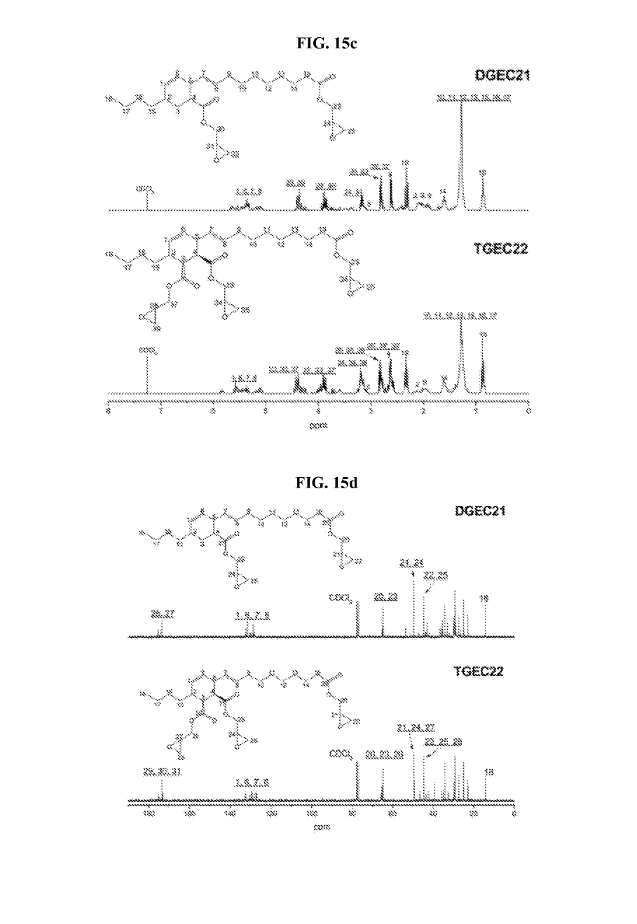

As described herein, intermediates C21DA and C22TA were synthesized by reacting methyl eleostearate with acrylic acid or fumaric acid via Diels-Alder reaction, respectively. See Scheme 6. The diglycidyl esters of C21 (DGEC21) and triglycidyl ester of C22 (TGEC22) were prepared from tung oil, respectively. For comparison with the properties of commercial epoxy and epoxidized soybean oil (ESO), bisphenol A epoxy resin (DER332) and ESO were used as comparative epoxy resins. Nadic methyl anhydride (NMA) was used as a curing agent to formulate epoxy-anhydride system. C21DA, C22TA, DGEC21 and TGEC22 can each have one or both of two possible isomeric structures because the dieneophile (for example, acrylic acid or fumaric acid) can add to one of two possible dienes in the tung oil triene of Scheme 6. Only one set of Diels-Alder product isomers is shown in Scheme 6. Two sets of Diels-Alder isomers are shown in FIGS. 14-15, one set of Diels-Alder products in FIGS. 14 and 15a and another set of isomers in FIGS. 15b-d. Both sets of Diels-Alder product isomers are encompassed by the compounds disclosed herein.

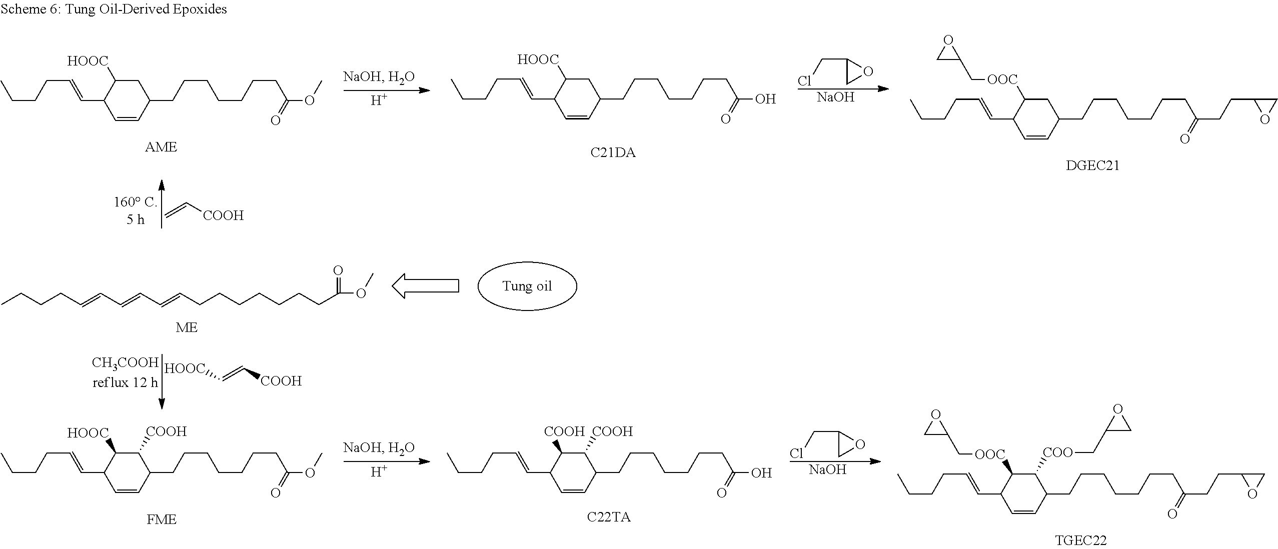

Two glycidyl esters were successfully synthesized from tung oil. The viscosities of glycidyl esters were as low as those of commercial reactive diluents for epoxy resins. Second, these two fatty acid glycidyl esters proved more reactive than commercial bisphenol A epoxy resin. As such, these two fatty acid glycidyl esters can achieve complete cure conversion through the common curing procedure for epoxy/anhydride thermosets. As shown in the Examples below, the thermosets cured with anhydride have much higher T_{g} and storage modulus than the cured ESO material and the tung oil based epoxy resin has high thermal stability. These kinds of glycidyl esters with rigid properties, low viscosity and high heat resistance are suitable for replacement of bisphenol A epoxy resin in some commercial applications. For example, tung oil based resins could be used as electron sealing resins, reactive epoxy diluents, electrical insulating materials and epoxy self-levelling flooring.

In another embodiment, a compound is provided, where the compound is of Formula XI:

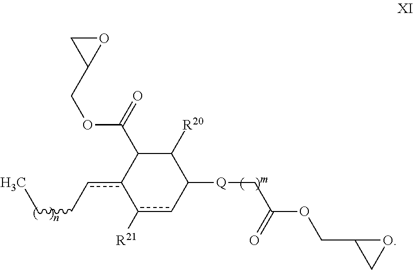

In the compound of Formula XI, R²⁰ is H or

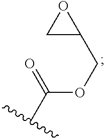 [SMILES: *C(=O)OCC1CO1]

### R²¹ is H or

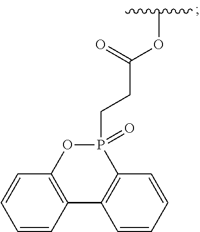 [SMILES: *OC(=O)CCP1(=O)Oc2ccccc2-c2ccccc21] [0222] Q is a bond or —CH═CH—; each n and m is independently an integer from 1 to 12; and each [symbol] is independently a single or double bond.

In some embodiments, the compound of Formula XI is a compound of Formula IV, V, VI, or VII:

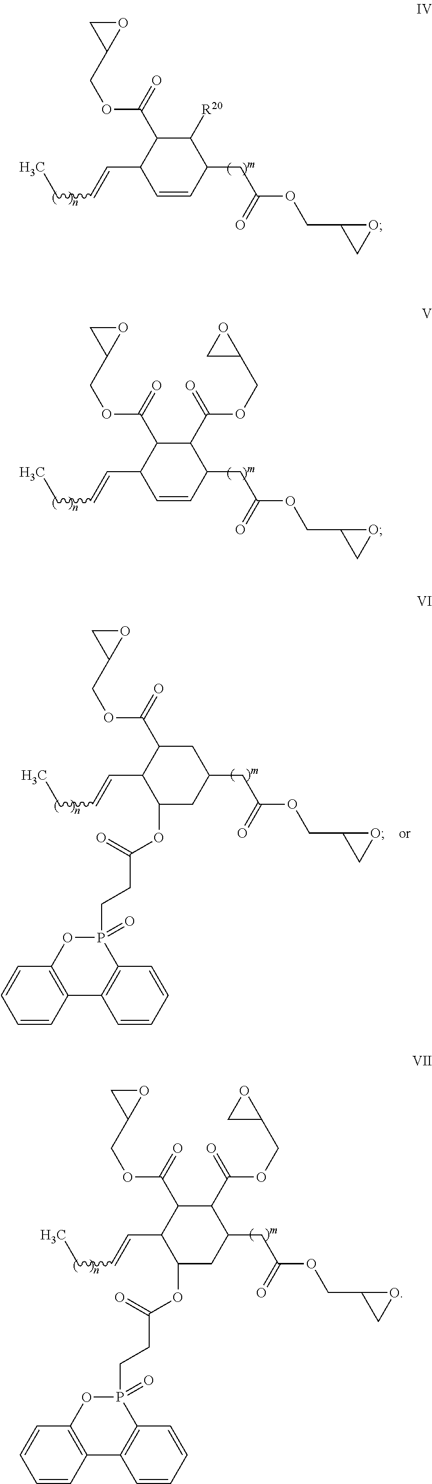

In the compounds of Formula IV, V, VI, or VII, each n and m is independently an integer from 1 to 12.

In some embodiments, m is 1, 2, 3, 4, 5, 6, 7, 8, 9, 10, 11 or 12. In some embodiments, n is 1, 2, 3, 4, 5, 6, 7, 8, 9, 10, 11 or 12. In some embodiments, n is 3. In some embodiments, m is 7.

In some embodiments, the compound of Formula XI is a compound of Formula IVa, Va, VIa, or VIIa:

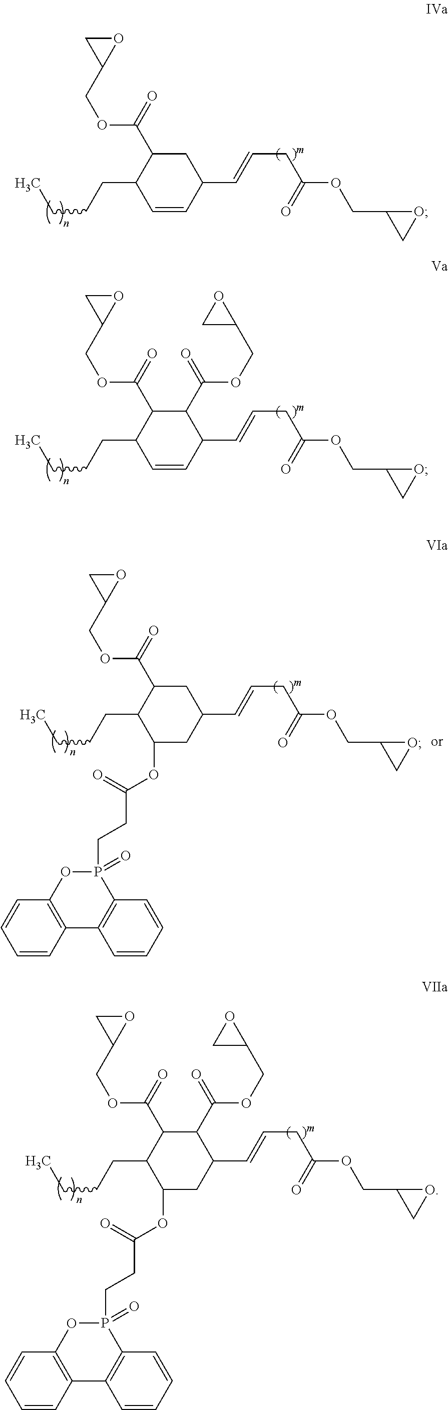

In the compounds of Formula IVa, Va, VIa, or VIIa, each n and m is independently an integer from 1 to 12.

In some embodiments, m is 1, 2, 3, 4, 5, 6, 7, 8, 9, 10, 11 or 12. In some embodiments, n is 1, 2, 3, 4, 5, 6, 7, 8, 9, 10, 11 or 12. In some embodiments, n is 1. In some embodiments, m is 7.

### Rosin-Derived Epoxy and Dimer Fatty Acid-Derived Epoxy

Rosin, exudate from pines and conifers, consists of ˜90% acidic chemicals called rosin acid and ˜10% volatile turpentines. Rosin acid is a mixture of different isomers consisting of a hydrogenated phenanthrene ring structure with a carboxylic acid group and two double bonds. Provided herein are data showing that rosin acid is a rigid alternative chemical to petroleum-derived aromatic and cycloaliphatic chemicals for the preparations of epoxies and curing agents. Rosin-derived anhydride (methyl maleopimarate, MMP) and acid-anhydride (maleopimaric acid, MPA) exhibits similar curing reactivity to that of their commercial counterparts 1,2-cyclohexanedicarboxylic anhydride and 1,2,4-benzenetricarboxylic anhydride, respectively, and the cured epoxy resins display comparable mechanical and dynamic mechanical properties as well. However, like most other epoxy resins, these rosin-based epoxies tend to be brittle.

As described herein, the diglycidyl ester of dimer fatty acid was prepared and used to modify the performance of a rigid rosin-derived epoxy, diglycidyl ester of acrylopimaric acid. Unlike epxoidized plant oils, the diglycidyl ester of dimer acid has two terminal epoxy groups which are more reactive than the internal oxiranes. See Scheme 7.

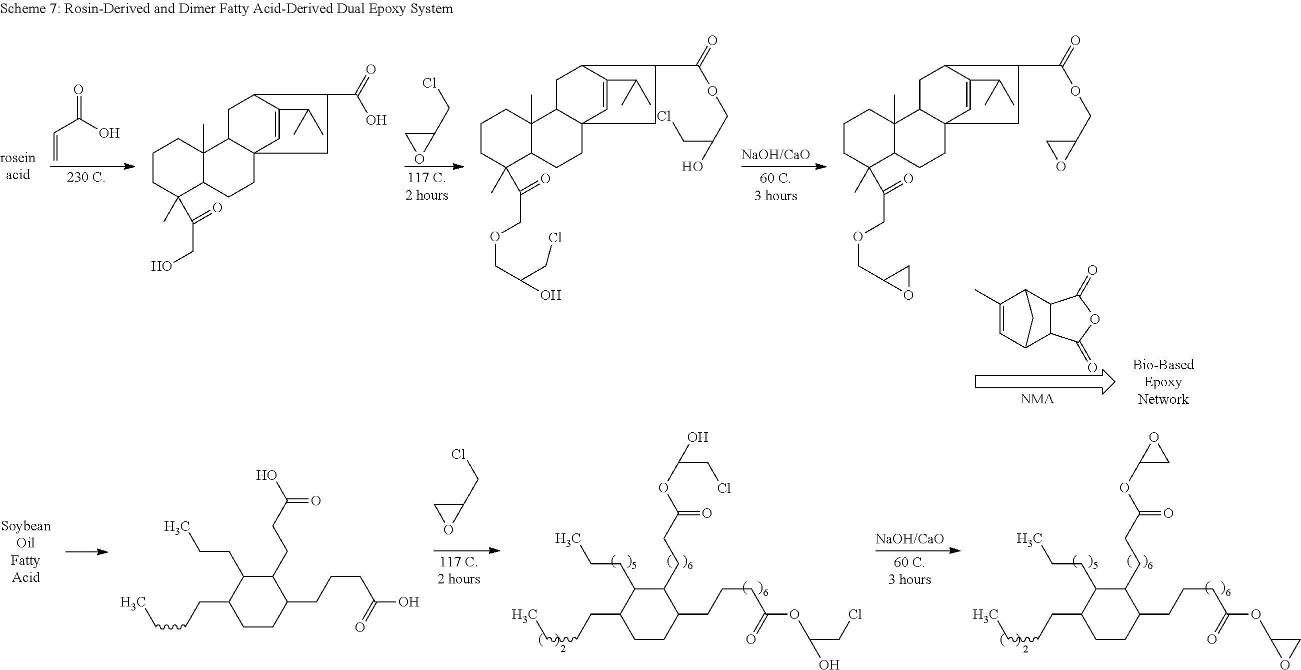

In addition to the dimeric acid starting material of Scheme 7, any of the dimeric acids of Table 2 can be used to make the diglycidyl esters described herein. In some embodiments, the diglycidyl ester derives from one or more acyclic dimeric acids of Table 2. In some embodiments, the diglycidyl ester derives from one or more monocyclic dimeric acids of Table 2. In some embodiments, the diglycidyl ester derives from one or more bicyclic dimeric acids of Table 2.

TABLE 2
Dimeric Fatty Acids

| Class | Structure |
|---|---|
| Acyclic | 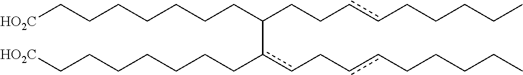 |
| Monocyclic | 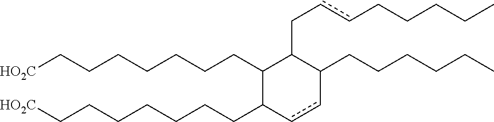 |
| Bicyclic | 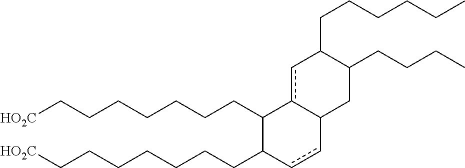 |
| | where each [symbol] is independently a single or double bond |

Also disclosed herein is a more effective method for preparing the glycidyl esters of rosin acid and dimer fatty acid by the use calcium oxide. In particular, calcium oxide was added as a water scavenger to form calcium hydroxide and preventing side reactions such as the hydrolysis of epichlorohydrin or saponification of esters. The two epoxies (rosin-derived and the dimer fatty acid) were mixed in different ratios and cured with a commercial curing agent, nadic methyl anhydride. Curing kinetics, flexural properties, dynamical mechanical properties and thermal stability of the cured resins were excellent.

The rosin-derived and dimer fatty acid-derived dual epoxy system containing about 20 wt % to about 40 wt % of dimer acid-derived epoxy exhibited overall high performance. The T_{g}, storage modulus and thermal stability of the cured resin increased with increasing content of rosin-derived epoxy in the mixed resin. The results described in the Examples section suggest that the rigid rosin-derived epoxy and the flexible dimer acid-derived epoxies possess complementary physical properties and mixtures of the two in appropriate ratios resulted in well-balanced properties and high performance.

In another embodiment, a compound is provided where the compound is of Formula VIII or IX:

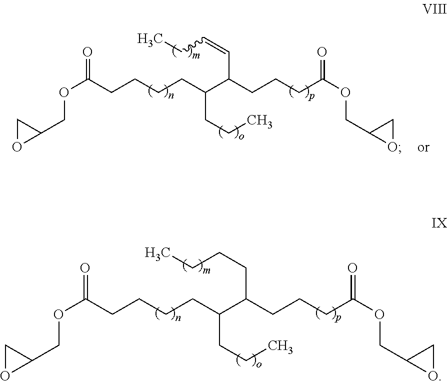

In the compounds of Formula VIII or IX, each n, m, o and p is independently an integer from 1 to 12.

In some embodiments, m is 1, 2, 3, 4, 5, 6, 7, 8, 9, 10, 11 or 12. In some embodiments, n is 1, 2, 3, 4, 5, 6, 7, 8, 9, 10, 11 or 12. In some embodiments, o is 1, 2, 3, 4, 5, 6, 7, 8, 9, 10, 11 or 12. In some embodiments, p is 1, 2, 3, 4, 5, 6, 7, 8, 9, 10, 11 or 12.

In another embodiment, a compound is provided where the compound is of Formula IXa, IXb or IXc:

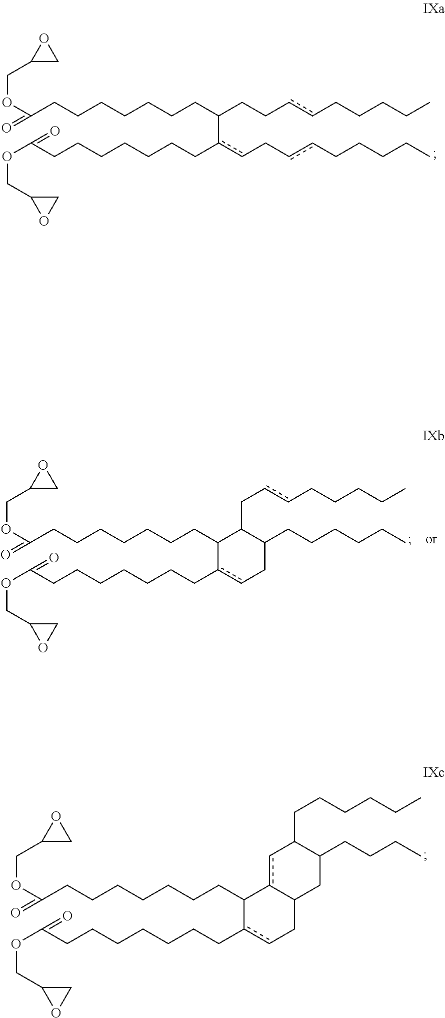

In the compounds of Formula IXa, IXb or IXc, each [symbol] is independently a single or double bond.

In another embodiment, a compound is provided where the compound is of Formula IXd:

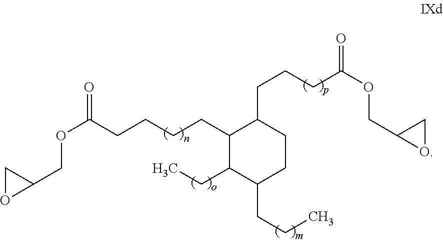

In the compounds of Formula IXd, each n, m, o and p is independently an integer from 1 to 12. In some embodiments, m is 1, 2, 3, 4, 5, 6, 7, 8, 9, 10, 11 or 12. In some embodiments, n is 1, 2, 3, 4, 5, 6, 7, 8, 9, 10, 11 or 12. In some embodiments, o is 1, 2, 3, 4, 5, 6, 7, 8, 9, 10, 11 or 12. In some embodiments, p is 1, 2, 3, 4, 5, 6, 7, 8, 9, 10, 11 or 12. In some embodiments, m is 4, o is 6, n is 5 and p is 6.

The following Scheme 8 depicts the preparation of representative derivatives of soybean oil as described herein:

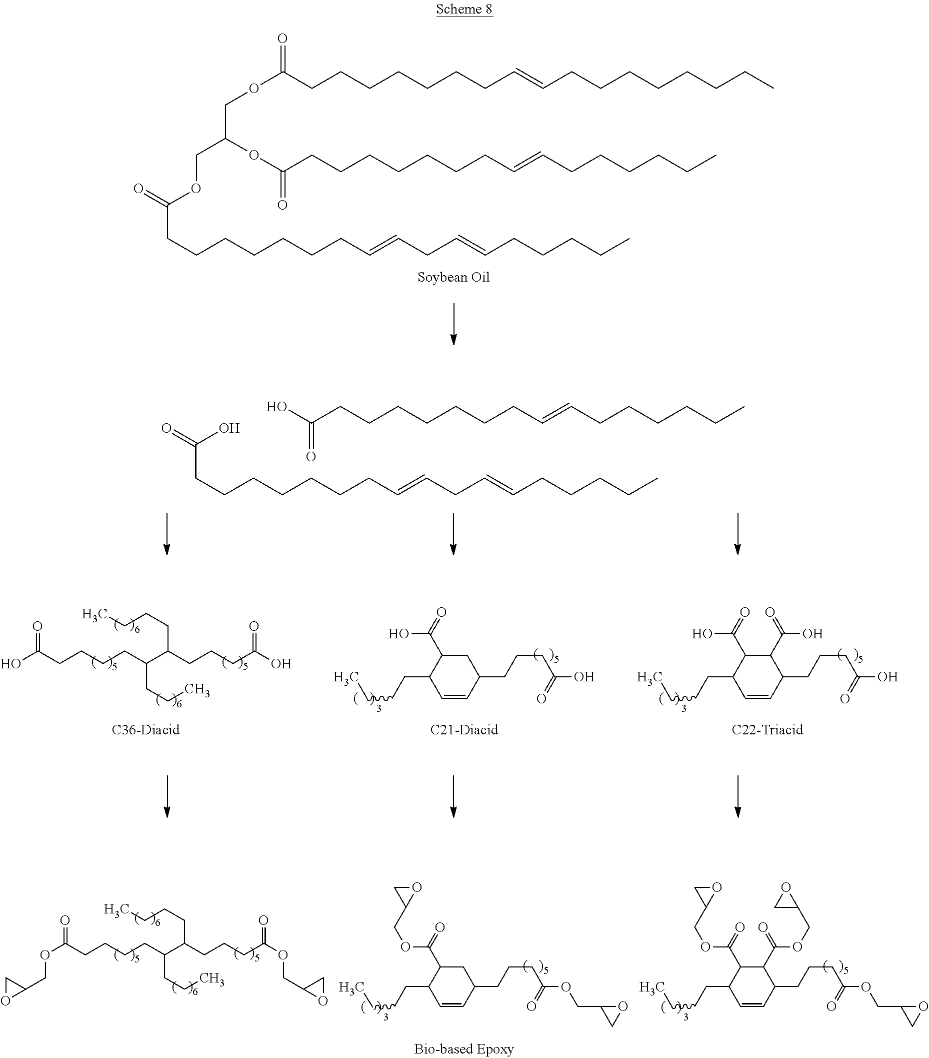

In another embodiment, a compound is provided where the compound is of Formula X or Xa:

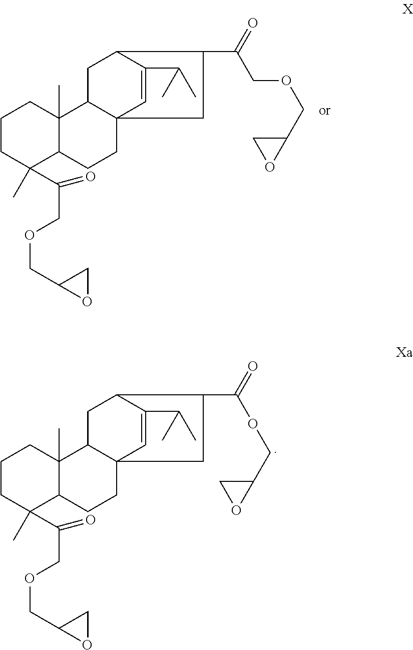 [SMILES: CC(C)C1=CC23CCC4C(C)(C(=O)COCC5CO5)CCCC4(C)C2CC1C(C(=O)COCC1CO1)C3 ; CC(C)C1=CC23CCC4C(C)(C(=O)COCC5CO5)CCCC4(C)C2CC1C(C(=O)OCC1CO1)C3]

In another embodiment, a composition is provided, wherein the composition comprises any of the compounds or co-polymers described herein and an additive. In some embodiments, the additive is selected from the group consisting of a photoinitiator, light stabilizer, curing accelerator, dye, pigment, devolatilizer, levelling agent, and any combination of two or more thereof.

In another embodiment, an epoxy resin is provided where the epoxy resin includes the reaction product from any of the compounds described herein, or any combination of two or more thereof, and a curing agent. In some embodiments, the curing agent is nadic methyl anhydride. In some embodiments the resin includes one or more of the compounds of Formulae I-XI. In some embodiments the resin includes one or more of the compounds of Formulae I-XI, where the resin includes about 20 wt % to about 40 wt % of the compound or Formulae I-XI. Also provided is an epoxy resin prepared by any one of the processes described herein.

In some embodiments, the epoxy resin further includes epoxidized soybean oil, bisphenol A, or a combination thereof.

In some embodiments, the epoxy resin further comprises a catalyst. In some embodiments, the catalyst is an imidazole. In some embodiments, the imidazole is 2-ethyl-4-methylimidazole.

In some embodiments of the epoxy resin, each n, m, o and p in the compounds of Formulae IV-XI is independently an integer from 1 to 12. In some embodiments, m is 1, 2, 3, 4, 5, 6, 7, 8, 9, 10, 11 or 12. In some embodiments, n is 1, 2, 3, 4, 5, 6, 7, 8, 9, 10, 11 or 12. In some embodiments, o is 1, 2, 3, 4, 5, 6, 7, 8, 9, 10, 11 or 12. In some embodiments, p is 1, 2, 3, 4, 5, 6, 7, 8, 9, 10, 11 or 12.

In some embodiments, any of the compounds of Formulae I-XI can be incorporated into UV curable resins having good mechanical properties and high UV stabilities. The UV-curable resins may further include, for example, additives which are customary in the coatings industry, in the amounts customary for those additives: they include a photoinitiator, light stabilizers, curing accelerators, dyes, pigments, for example, titanium dioxide pigment, devolatilizers, or levelling agents. Suitable additives, such as photoinitiators, are known to the person skilled in the art and some are also available commercially. The additive content may be, for example, from about 0.1 wt % to 25 wt %.

In another embodiment, an article is provided where the article includes any of the compounds of Formulae I-XI, co-polymers or compositions described herein. Non-limiting representative articles may include epoxy resins, curing agents, flame retardants, UV curable agents, and the like.

In another embodiment, a process for preparing an epoxy resin is provided where the process includes: mixing any of the compounds of Formulae I-XI, as shown herein, or a combination thereof, with a curing agent to form the epoxy resin.

In some embodiments of the process, the curing agent is nadic methyl anhydride. In some embodiments, the process further includes adding a catalyst. In some embodiments, the catalyst is an imidazole. In some embodiments, the imidazole is 2-ethyl-4-methylimidazole.

The present technology, thus generally described, will be understood more readily by reference to the following examples, which is provided by way of illustration and is not intended to limit the present technology.

### EXAMPLES

### Part I—Examples 1-4

### Acrylation and Co-Polymerization of Soybean Oil

### Example 1

### Acrylation of Soybean Oil

Soybean oil (SO) was directly acrylated in the presence of BF₃.Et₂O, as shown in Scheme 1. Representative reaction conditions are shown in Table 3. The mixtures of SO, acrylic acid (AA) and BF₃.Et₂O in various stoichiometric ratios were reacted under stirring at 80° C. for different times (Table 3). Depending on the size of reaction, two different work-up procedures were employed. In Table 3, for the small size reactions (entries 1-5) which were to investigate the reaction conditions, the excess AA and catalyst were removed by NaHCO₃ aq. washing directly. For the large size reactions (entries 6 & 7) the excess AA and catalyst were removed by distillation at 35-45° C. under reduced pressure, and the recovered AA and catalyst were reused.

TABLE 3
Stoichiometry of the acrylation of SO and conversion of the double bonds

| | SO^{a} | AA | BF₃Et₂O | Conversion^{b} % | | | | | |
|---|---|---|---|---|---|---|---|---|---|
| Entry | mmol/eq^{d} | mmol/eq | mmol/eq | 2 h | 3 h | 4 h | 6 h | 24 h | Yield^{c} % |
| 1 | 18.2/1 | 30/1.65 | 0.016/9 × 10⁴ | 0 | \ | 0 | 0 | Polymerized | |
| 2 | 18.2/1 | 30/1.65 | 5/0.27 | 35.5 | \ | 37.2 | 37.5 | 32.5 | \ |
| 3 | 18.2/1 | 30/1.65 | 25/1.37 | 29.4 | \ | 25.3 | 24.5 | 7.6 | \ |
| 4 | 18.2/1 | 80/4.39 | 25/1.37 | 47.8 | \ | 50.0 | 52.4 | 39.4 | \ |
| 5 | 3.65/1 | 100/27.4 | 5/1.37 | 49.4 | \ | 59.5 | 64.7 | 80.3 | \ |
| 6 | 72.9/1 | 2000/27.4 | 100/1.37 | \ | 59.3 | \ | \ | \ | 90.9 |
| 7 | 72.9/1 | 2000/27.4 | 100/1.37 | \ | \ | \ | 75.7 | \ | 71.6 |

^{a}The content of double bonds in soybean oil was determined by iodine value titration;
^{b}Conversion of double bond to acrylate was tracked by ¹H NMR;
^{c}Based on theoretical product of 100% conversion;
^{d}The unit “mmol” means the milli mole number of reagent used in reaction, “eq” means the equivalent units with respect to 1 equivalent double bonds of SO.

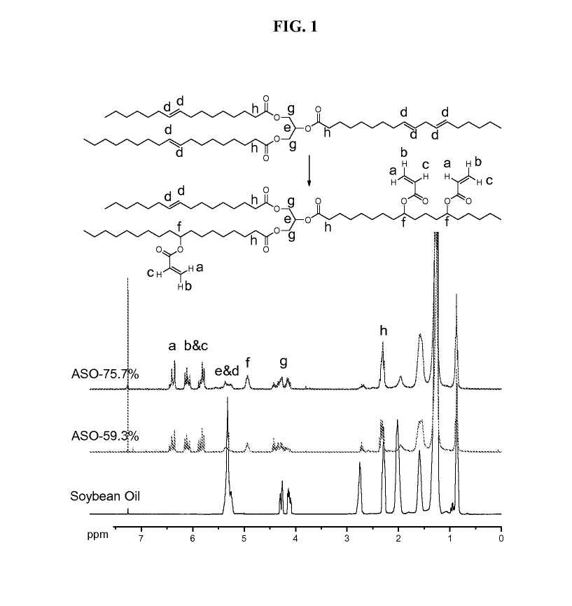

FIG. 1 shows ¹H NMR spectra of soybean oil and acrylated soybean oil (ASO) (entries 6 and 7, Table 2). The ratio of the peak area of Hₕ to that of H_{g} of SO was exactly 6:4, confirming the triglyceride structure of the SO. The average number of double bonds per SO molecule was determined from the ratio of the peak area of Hₕ (2.20-2.40 ppm) to that of H_{d}. Since the chemical shift of the proton on the double bonds (H_{d}) overlapped with that of the methine proton (Hₑ) of the glycerol residue, the peak area attributed to H_{d} could be determined by subtracting the portion of Hₑ from the total peak area of H_{d} and Hₑ (5.17-5.44 ppm). According to the triglyceride structure of SO, the peak area of Hₑ was a quarter of the peak area of H_{g} (4.05-4.35 ppm). The degree of acrylation was determined by the ratio of the peak area of Hₕ (2.20-2.40 ppm) to that of Hₐ (6.30-6.50 ppm) in the spectrum of ASO. For entries 6 and 7, the numbers of acrylate groups per triglyceride were found to be 2.42 and 3.09, respectively. Based on the average double bond number of 4.08 for the original SO, the calculated conversion of double bonds to acrylate groups were 59.3% (ASO-59.3%) and 75.7% (ASO-75.7%), respectively.

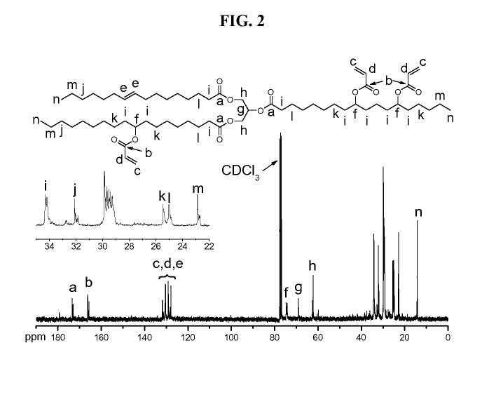

FIG. 2 shows the ¹³C NMR spectrum of ASO and the assignments of chemical shifts to individual carbons. The chemical shifts of 173.41/172.99 and 166.24/166.16/165.69 ppm were attributed to the carbonyl of triglyceride and carbonyl of acrylate, respectively. The chemical shifts associated with the residual double bonds of SO and the double bonds of acrylate appeared at 131.81, 130.36, 129.16, 129.07, 128.99 and 127.90 ppm, respectively. The chemical shifts of other carbons in ASO were also identified in the spectrum. The chemical shifts from 29 to 30 ppm were attributed to those unlabeled carbons in the ASO structure. This result was in agreement with that in the reported ¹³C NMR spectra of vegetable oil and methyl acrylate.

### Example 2

### The Effects of Stoichiometric Ratio of Reactants and Reaction Time on the Conversion of Double Bonds

Table 3 shows the effect of variable stoichiometric ratios of reactants and reaction times on the conversion of double bonds soybean oil. The conversion of double bond to acrylate was determined by ¹H NMR. Although BF₃.Et₂O behaved like a high efficiency catalyst in the synthesis of acrylated norbornene, no ASO product was found at the similar low BF₃.Et₂O concentration (9×10⁻⁴ eq on the basis of double bonds in SO) in the acrylation of SO (entry 1). Increasing the reaction time to 24 h resulted in the polymerization of AA. When 0.27 eq BF₃.Et₂O was used, the conversion of the double bonds of SO at 2 h was 35.5% and remained almost the same as reaction time increased (entry 2). However, the conversion decreased when BF₃.Et₂O was increased to 1.37 eq (entry 3). The conversion was increased by increasing the AA content (entry 4). The decrease in conversion at 24 h of reaction for entries 2-4 was potentially due to the polymerization of some of the ASO formed. When AA was dominant in the reaction medium, however, homopolymerization of AA would outperform the copolymerization. For example, the conversion at 24 h of reaction increased as the AA content increased from 4.39 eq (entry 4) to 27.4 eq (entry 5). To reduce the polymerization between ASO and AA, the AA content was increased to 27.4 eq (entry 5) and the conversion reached as high as 80.3% after 24 h of reaction. For the two scale-up reactions, the conversion reached to 59.3% at 3 h and 75.7% at 6 h.

### Example 3

### Preparation of Unsaturated Polyesters from ASO and Styrene

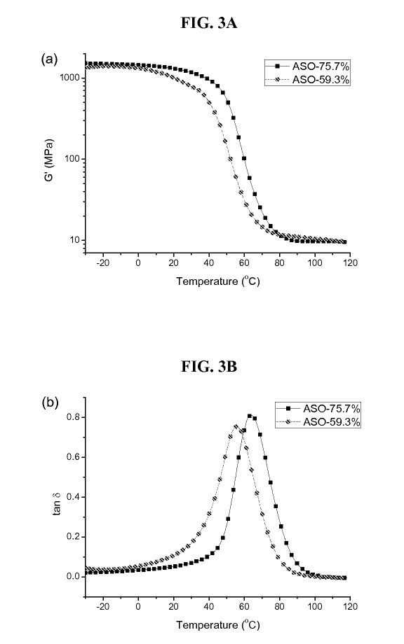

The copolymerization of the ASO (entries 6 and 7) with styrene was performed as follows. ASO (60 parts), styrene (40 parts), benzoyl peroxide (BPO, 3 parts) and dimethyl aniline (DMA, 0.6 parts as accelerator) by weight were mixed well and poured into a mold with cavities for straight bars. The initial curing was performed at 140° C. for 2 h. The samples were removed from the mold and aged at 180° C. for another 12 h. Flexural and dynamic mechanical properties of the cured resins were evaluated. See FIGS. 3A and 3B.

FIGS. 3A and 3B depict the storage modulus (a) and tan δ (b) versus temperature for cured unsaturated polyester samples with different ASO. FIGS. 3A and 3B show the effect of acrylation degree of ASO on dynamic mechanical properties. The storage moduli (G′) of the two cured resins at 25° C. were 892.4 MPa and 1247.3 MPa for the cured ASO-59.3% and ASO-75.7%, respectively. Glass transition temperature (T_{g}) of the cured resin is determined from the peak temperature of the α-transition in the tan δ curve. The T_{g} of the sample prepared from ASO-75.7% was 63.7° C. which was higher than that of the T_{g} (55.5° C.) of the sample from ASO-59.3%. This result suggests that under the same composition the resin from the ASO with higher acrylation degree exhibited higher stiffness and T_{g}. This result was most likely due to the difference in crosslink density between the two cases where the ASO with higher acrylation degree tended to yield a cured resin with higher degree of crosslinking.

### Example 4

### Bending Tests of the Cured Samples

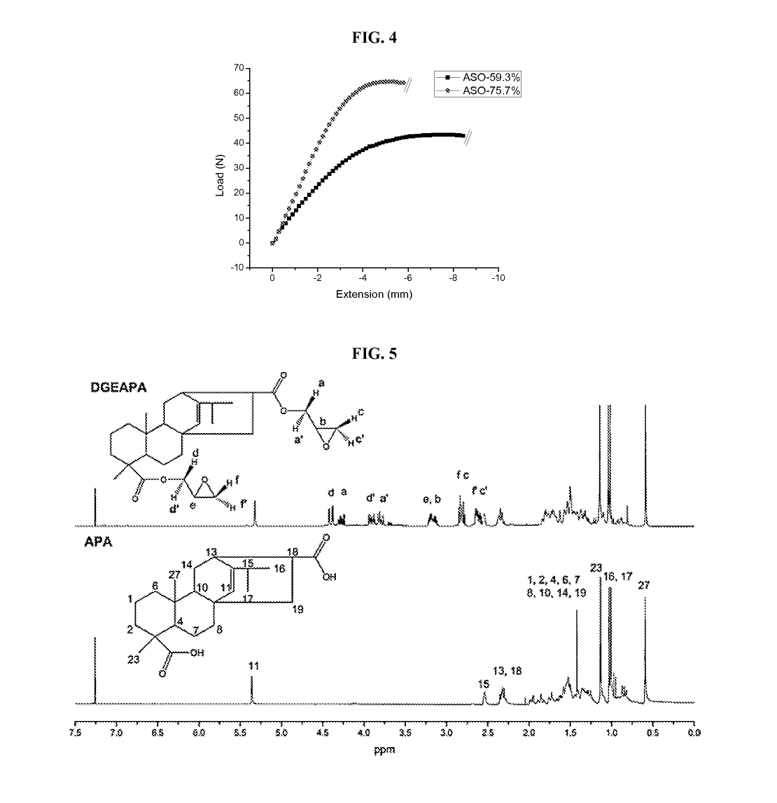

Bending tests of the cured samples were performed according to ASTM D790. Both samples exhibited a yielding behavior and did not break during testing. The elasticity modulus (MOE), yield strength and yield strain of the resin prepared from ASO-59.3% (entry 6) were 577±95 MPa, 24.2±2.4 MPa and 8.0±0.4%, respectively. In contrast, the MOE, yield stress and yield stain of the resin prepared from ASO-75.7% (entry 7) were 1153±80 MPa, 42.4±5.5 MPa and 5.7±0.3%, respectively. These results of blending tests were in agreement with that of DMA tests. See FIG. 4.

### Part I

### Examples 1-4: Summary

Examples 1-4 demonstrated that ASO could be prepared by addition of SO and AA under the catalysis of BF₃.Et₂O in an one-step reaction. Conversion of the double bonds increased greatly with increases in acrylic acid and catalyst concentrations. Furthermore, reaction time also had a significant influence on the conversion and yield, and prolonged reaction time tended to increase the chance for the AA and ASO to polymerize.

### Part II

### Examples 5-15: Synthesis Routes of APA, DGEAPA and DGEDA

The synthesis of DGEAPA and DGEDA followed a two-step process with modification. The first step involved addition of APA or DA to epichlorohydrin under the catalysis of tetrabutyl ammonium chloride and formation of a chlorohydrin intermediate. An excess amount of epichlorohydrin was used as the solvent for the reaction. The second step was the dehydrohalogenation of the intermediate to form the glycidyl ester in the presence of solid sodium hydroxide and calcium oxide. Sodium hydroxide acted as the dehydrohalogenating agent and neutralized the resulting hydrogen chloride. It was noted that solid sodium hydroxide could easily dissolve in the product of the first stage. Because water was formed in the neutralization, calcium oxide was also added to the reaction as a water scavenger, so the hydrolysis of epichlorohydrin or saponification of esters could be largely prevented. No other solvent was introduced except epichlorohydrin which was recycled and could be reused. According to the test of epoxy equivalent, the yield of the product prepared from recycled epichlorohydrin was almost the same to the yield from fresh epichlorohydrin. Except for sodium salts and calcium hydroxide, there is no other waste during the two-step method.

Materials:

Dimer fatty acid (95% of dimers, acid value 190 mg/g) was obtained from Shanghai Guxiang Chemical Company. Epichlorohydrin, sodium hydroxide (98.7%, J. T. Baker), nadic methyl anhydride (99.4%, Electron Microscopy Sciences) and 2-ethyl-4-methylimidazole (99+%, Acros Organics) were used as received.

### Example 5

### Synthesis of Acrylopimaric Acid (APA)

The protocol of Halbrook and Lawrence was used. N. J. Halbrook and R. V. Lawrence, Ind. Eng. Chem. Prod. Res. Dev., 1972, 11, 200-202. Gum rosin (300 g) was charged to a flask equipped with a stirrer, dropping funnel, inert gas inlet, thermometer, and reflux condenser. The temperature was raised to 230° C., and acrylic acid (76.5 g) was added slowly. The reaction continued for 3 h at 230° C. after all the acrylic acid was added. The crude product (100 g) was recrystallized using a petroleum ether/ethyl acetate (85/15 v/v) mixture, then 52 g purified acrylopimaric acid was obtained (yield: 52%). The purity of the obtained acrylopimaric acid was 93% (GC). (16) N. J. Halbrook and R. V. Lawrence, Ind. Eng. Chem. Prod. Res. Dev., 1972, 11, 200-202.

### Example 6

### Synthesis of Diglycidyl Ester of Acrylopimaric Acid (DGEAPA)

To a 50 mL flask equipped with reflux condenser, magnetic stirrer and thermometer were charged 3.740 g (10 mmol) APA, 18.500 g (200 mmol) epichlorohydrin and 0.023 g (0.1 mmol) benzyltriethyl ammonium chloride. The reaction temperature was raised to 117° C. and the reaction continued at that temperature for 2 h. After the mixture was cooled to 60° C., 0.800 g (20 mmol) sodium hydroxide and 1.120 g (20 mmol) calcium oxide were charged. The mixture was stirred at 60° C. for 3 h and then filtered by celite and filter paper. The solid was discarded. After the excess epichlorohydrin was distilled under vacuum at 100° C. from the filtrate, 4.2 g yellowish viscous resin was obtained. The product was purified using a silica gel column (ethyl acetate:hexane=1:2 v/v) to receive 4 g pure diglycidyl esters (yield: 88% relative to pure APA) with an epoxide equivalent weight 243 g/mol (theory: 243 g/mol). The pure diglycidyl esters contained two isomers corresponding to the two APA isomers. ¹H-NMR (CDCl₃, δ ppm) 5.32 (s, 1H), 4.38-4.43 (q, 1H), 4.24-4.29 (q, 1H), 3.88-3.94 (q, 1H), 3.77-3.83 (q, 1H), 3.17-3.21 (m, 1H), 3.12-3.16 (m, 1H), 2.82-2.85 (t, 1H), 2.78-2.81 (t, 1H), 2.62-2.66 (m, 1H), 2.57-2.60 (m, 1H), 2.55 (m, 1H), 2.30-2.37 (m, 2H), 1.27-1.84 (m, 16H), 1.14 (s, 3H), 1.04 (s, 3H), 1.02 (s, 3H), 0.59 (s, 3H). FTIR (cm⁻¹) 764, 849, 910, 1149, 1246, 1728, 2866, 2933. ESI-MS m/z 487.4, [M+H⁺].

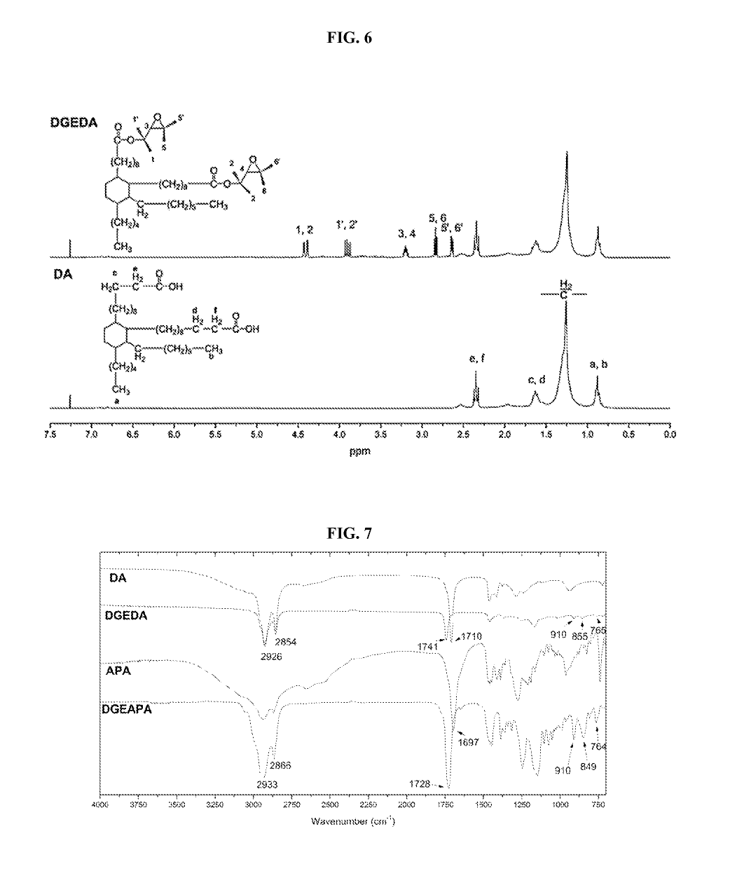

FIG. 5 depicts ¹H-NMR spectra of APA and DGEAPA. In the spectrum of DGEAPA, the chemical shift from 2.60-4.43 ppm indicated the protons of glycidyl ester groups. FIG. 6 displays the ¹H-NMR spectra of DA and DGEDA. DA is a mixture of C36 aliphatic dibasic acids. Possible structures include a linear dimer acid with two alkyl side chains, alicyclic, aromatic and polycyclic dimer acids. The composition of these structures depends on the level of unsaturation in the starting C18 fatty acids and other reaction conditions. In the spectrum of DGEDA, the chemical shift at 2.63-4.43 ppm was attributed to the protons of glycidyl ester groups. FIG. 7 shows the FTIR spectra of acids and the diglycidyl esters. The peaks at 765, 855 and 910 cm⁻¹ were the characteristic peaks of epoxide. The peaks at 1728 and 1741 cm⁻¹ were the C═O stretching vibrations of DGEAPA and DGEDA which differentiated from the C═O stretching vibrations of APA and DA at 1697 and 1710 cm⁻¹, respectively.

### Example 7

### Synthesis of Diglycidyl Ester of Dimer Acid (DGEDA)

The method is the same as that for the synthesis of acrylopimaric acid diglycidyl esters. The product is a light yellowish liquid with an epoxide equivalent weight 389 g/mol (theory: 351 g/mol calculated by acid value of the dimer acid). Since the dimer fatty acid is a mixture of various isomers with similar structures, DGEDA was not further purified and used as prepared. ¹H-NMR (CDCl₃, δ ppm) 4.42-4.43 (d, 1H), 4.38-4.39 (d, 1H), 3.91-3.93 (d, 1H), 3.87-3.89 (d, 1H), 3.17-3.23 (m, 2H), 2.82-2.85 (t, 2H), 2.63-2.65 (q, 2H), 2.32-2.37 (t, 4H), 1.59-1.67 (m, 4H), 1.25 (m, 46H), 0.85-0.89 (t, 6H). FTIR (cm⁻¹) 765, 855, 910, 1173, 1254, 1741, 2854, 2926.

### Example 8

### Preparation of Cured Samples for Testing

DGEAPA and DGEDA were mixed by weight ratios of 5/0, 5/1, 5/3, 5/5, 1/5 and 0/5, respectively. Nadic methyl anhydride (NMA) was used as the curing agent. In all formulations, epoxy and anhydride were maintained in the stoichiometric ratio, i.e., in a 2/1 molar ratio (i.e., 1/1 equivalent ratio) 2-Ethyl-4-methylimidazole was used as the catalyst and added at 1 wt % on the basis of total weight of curing agent and epoxy. The ingredients were mixed at 50° C., and then the mixture was charged into a steel mold (preheated at 120° C.) with cavity dimensions of 65×13×3 mm. Curing was performed at 120° C. for 2 h, 160° C. for 2 h and 180° C. for 1 h. The cured specimens were carefully removed from the mold and used for flexural test, dynamic mechanical analysis (DMA) and thermogravimetric analysis (TGA).

### Example 9

### Characterizations

¹HNMR spectra of the compounds in deuterated chloroform (CDCl₃) were recorded with a Bruker 300 MHz spectrometer at room temperature. Chemical shifts relative to that of chloroform (d 7.26) are reported. FT-IR spectra were recorded using a Thermo Nicolet Nexus 670 spectrometer with a resolution of 4 cm⁻¹ and 32 scans. For the solid APA, a small amount of sample was grinded with dried KBr powder and then compressed into disks for the FT-IR test. For liquid samples, the FT-IR specimens were prepared by smearing the solution in dichloromethane onto a KBr crystal plate and evaporating the solvent under vacuum at 50° C. Mass spectra were recorded with an LCQ Advantage electrospray ionization mass spectrometry (ESI-MS) instrument.

### Example 10

### Curing Kinetics

Curing kinetics was studied by differential scanning analysis (DSC) using a 2920 MDSC (TA Instruments) instrument. Epoxy and NMA in a 1:1 equivalent ratio and 2-ethyl-4-methylimidazole (1 wt % on the basis of the total weight of curing agent and epoxy) were mixed. Approximately 5-10 mg of each sample was weighed and sealed in 40 μL aluminum crucibles and the curing on DSC was performed immediately. DSC analysis for each sample was repeated twice. The sample was scanned from 35 to 250° C. at heating rates of 5, 10, 15, 20 and 25° C./min, respectively.

### Example 11

### Curing Behavior

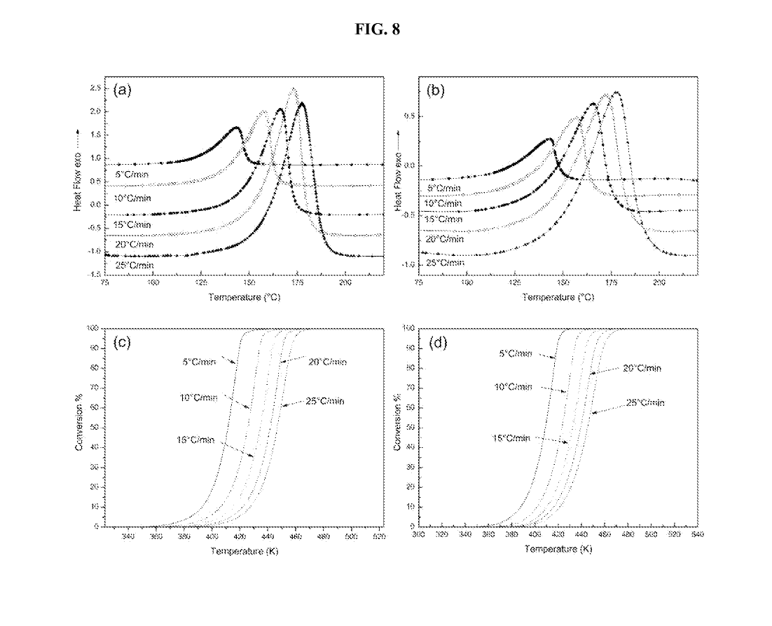

FIG. 8 shows the DSC thermograms of curing of DGEDA/NMA and DGEAPA/NMA at different heating rates and the calculated α as a function of temperature according to Eq (1). The DSC results are summarized in Table 4. Each sample exhibited one exothermic peak during the non-isothermal curing. As the heating rate (φ) increased, initial curing temperature (Tᵢ), peak exothermic temperature (Tₚ) and temperature at curing end (Tₑ) all shifted to higher temperatures. The shift of curing temperature with heating rate was a typical methodological phenomenon for non-isothermal curing. Nevertheless, the dependence of cure kinetics on heating rate could be eliminated by extrapolating the results to infinitely slow heating rates (isothermal conditions), yielding a “true” cure reaction temperature. Table 4 shows that the cure reaction temperatures at the zero heating rate ranged from 114.1 to 145.9° C. for DGEAPA/NMA and from 107.4 to 143.1° C. for DGEDA/NMA, respectively. If the initial curing, peak and curing end temperatures at the zero heating rate can be used as references for the selection of temperatures in the isothermal curing study, then these temperatures fell within the same range of the conventional epoxy curing temperatures.

For either DGEDA/NMA or DGEAPA/NMA, however, the total reaction enthalpy changed little with heating rate. The cure reaction enthalpy of DGEDA/NMA on the mass basis was ˜63.5% of that of DGEAPA/NMA, which corresponded very well with the ratio of epoxy equivalent weights of the two epoxies (i.e. ˜62.5%). As shown in Table 4, the curing of these two epoxies with NMA exhibited very similar total reaction enthalpy on the molar basis. The almost identical peak exothermic temperatures for curing of DGEAPA and DGEDA at each heating rate indicated that their epoxy groups had very similar reactivity.

TABLE 4
DSC results of curing of DGEAPA and DGEDA with
NMA at different heating rates

| | Φ | ΔH | ΔH | | | Tₑ |
|---|---|---|---|---|---|---|
| Samples | (° C./min) | (J/g) | (KJ/mol)^{a} | Tᵢ (° C.) | Tₚ (° C.) | (° C.) |
| DGEAPA/ | 0^{b} | 186.8 | 45.4 | 114.1 | 138.4 | 145.9 |
| NMA | 5 | 181.5 | 44.1 | 118.6 | 143.5 | 152.8 |
| | 10 | 184.4 | 44.8 | 134.3 | 157.6 | 164.2 |
| | 15 | 178.0 | 43.3 | 141.1 | 166.4 | 173.6 |
| | 20 | 185.6 | 45.1 | 148.2 | 173.1 | 180.6 |
| | 25 | 169.1 | 41.1 | 153.4 | 178.1 | 187.8 |
| DGEDA/ | 0^{b} | 112.7 | 43.8 | 107.4 | 138.0 | 143.1 |
| NMA | 5 | 112.4 | 43.7 | 111.4 | 143.5 | 150.1 |
| | 10 | 115.4 | 44.9 | 124.4 | 157.0 | 166.2 |
| | 15 | 113.3 | 44.1 | 131.6 | 165.7 | 177.1 |
| | 20 | 113.8 | 44.3 | 136.9 | 172.4 | 185.1 |
| | 25 | 115.6 | 45.0 | 141.4 | 178.0 | 192.4 |

^{a}On the basis of per mole of epoxide.
^{b}Linear extrapolation at dT/dt = 0.

### Example 12

### Activation Energy

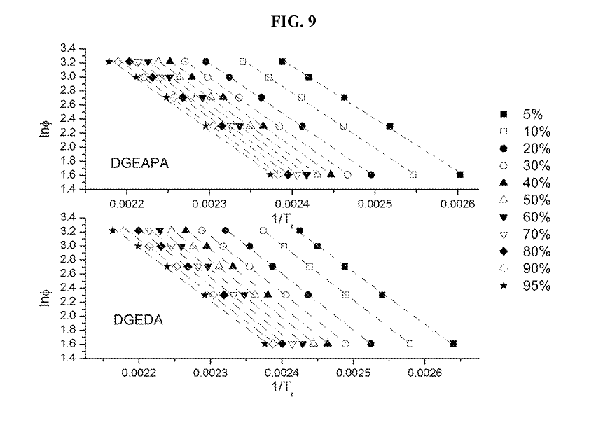

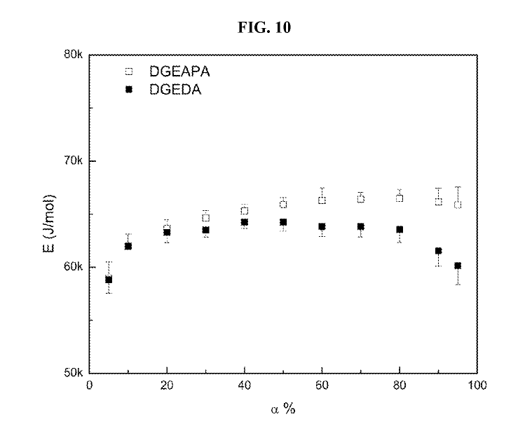

The reactivity of these two epoxy resins could also be evaluated by activation energy. From Eq. (2), FIG. 8(a) and FIG. 8(b), the plot of ln φ against 1/Tᵢ was carried out in FIG. 9 which enables the calculation of the activation energy for the α from 5 to 95% by the Ozawa method. See T. J. Ozawa, Therm. Anal., 1970, 2, 301-324. FIG. 10 shows the activation energy increased gradually with the extent of cure but decreased in the later stage of the curing. The change of activation energy was probably due to the variation of the mobility of the reactive groups of the partially cured epoxy throughout the curing process. The diffusion coefficient of the monomers depended on the curing temperature. In the beginning, the curing temperature was not high but the glass transition temperature of the polymer kept increasing, therefore, the diffusion of monomers and oligomers was hindered and activation energy increased gradually. Later, the curing temperature continued to increase but the glass transition temperature of the polymer remained stable, which resulted in the decrease of activation energy. This trend was particularly apparent for DGEDA/NMA system due to the low glass transition temperature of the cured product.

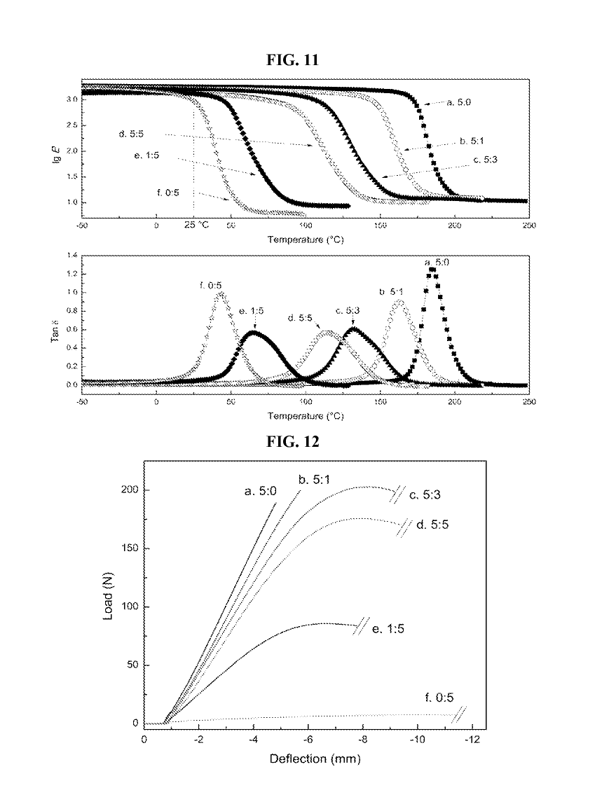

The mean values of activation energy of DGEDA/NMA and DGEAPA/NMA in FIG. 11 were 62.6 KJ/mol and 64.7 KJ/mol, respectively, which were lower than that (74.7 KJ/mol) of bisphenol A glycidyl ethers cured by hexahydro-4-methylphthalic anhydride. See F. Y. C. Boey and W. Qiang, Polymer, 2000, 41, 2081-2094. At low conversion, DGEDA and DGEAPA demonstrated almost the same activation energy of curing, indicating that they possessed very similar chemical reactivity in reacting with NMA. However, as the curing proceeded, the activation energy of DGEAPA curing with NMA gradually leveled off, while that of DGEDA curing with NMA reached a plateau and then declined at high conversion. This result was likely attributed to the factor that curing became more diffusion-controlled. Consequently, the effect of temperature increase on curing was largely offset by that of quick increase in molecular chain rigidity for the rosin-derived epoxy which had a rigid fused ring structure. On the contrary, the dimer acid-derived epoxy had a long flexible aliphatic chain which would allow significant diffusion.

### Example 13

### Dynamic Mechanical Analysis

FIG. 11 shows the changes of storage modulus (E′) and damping (tan δ) of the cured epoxies with temperature. The peak temperature of tan δ corresponds to the glass transition temperature (T_{g}). It is noted that all samples exhibited a single T_{g}, indicating both mixed epoxy and neat epoxy formed homogeneous crosslinked structures. Since DGEAPA and DGEDA had very comparable reactivity towards reacting with the curing agent NMA, this result suggests that the two epoxies participated in polymerization and crosslinking similarly during curing process and resulted in statistic random copolymers. After curing with NMA, rosin-derived epoxy exhibited a T_{g} of ˜185° C. which was gradually lowered with increasing addition of DA-derived epoxy. In FIG. 11, it was noted that the width of the tan δ peak became broader as the content of DA-derived epoxy increased. The broadening of tan δ peak was probably due to the greater degree of heterogeneity of crosslinked structures. Since DGEAPA and NMA both have cycloaliphatic structures, the cured resin possessed very high rigid molecular structure, therefore, high tan δ and a sharp transition as well. When the DA-derived epoxy, which had a long hydrocarbon segment between oxiranes and two pendent alkyl chains, was introduced into the system, the cured resin presented a relatively large degree of heterogeneity in molecular structure.

The addition of DA-derived epoxy also decreased E′ of the cured resins. DGEAPA/NMA had a highest E′ at 25° C. while DGEDA/NMA had the lowest one at the same temperature. This result is in agreement with that of the flexural modulus results. The E′ at rubbery stage can be used to estimate the crosslink density of the thermosets. Generally, A higher E′ at rubbery stage corresponds to a higher crosslink density at a certain temperature. In FIG. 12, generally, the rubbery stage modulus decreased as the content of DGEDA increased which indicated the crosslink density dropped when the DGEDA was added gradually.

### Example 14

### Flexural Properties

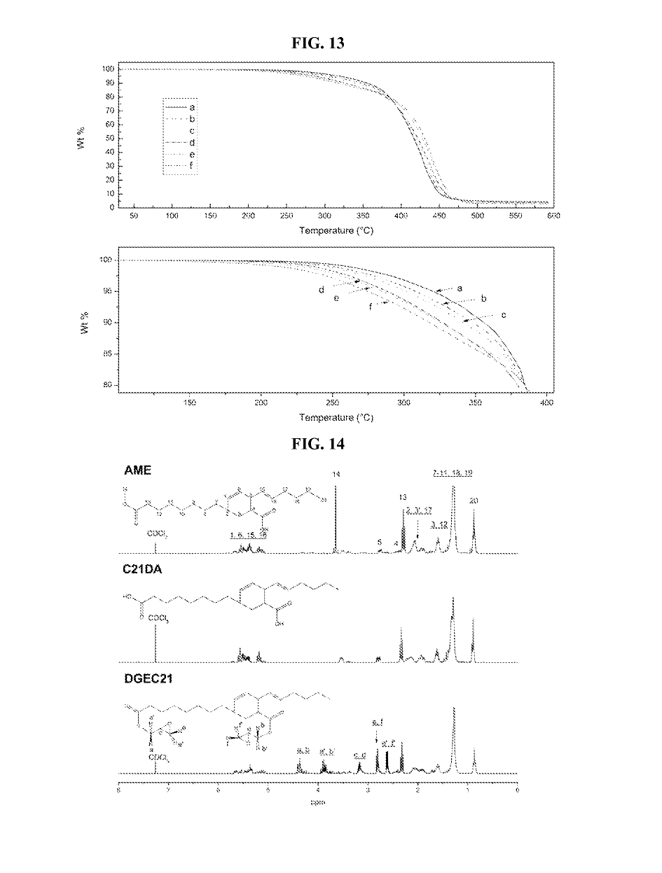

FIG. 13 shows the representative load-deflection curves of the cured epoxies. Neat DGEAPA (a) exhibited a rigid behavior without yielding and broke at a strain of 3.7% during flexural testing. Its modulus (3.11 GPa) was very similar to that of diglycidyl ether of bisphenol A cured with 4-methyl-hexahydrophthalic anhydride, but its flexural strength (108.5 MPa) was much higher than that of the latter (84.2 MPa). See F. Liu, Z. Wang, Y. Wang and B. J. Zhang, Polym. Sci. Pol. Phys., 2010, 48, 2424-2431.

Incorporation of dimer acid-derived epoxy greatly flexibilized the cured resins as seen in the decrease of modulus with DGEDA content. Likewise, the flexibilizing effect of DGEDA was also reflected in the change of flexural strain of the cured resins. With 16.7% DGEDA, the cured epoxy resin exhibited improved deformability with a strain at break of ˜4.5%, but still broke in a brittle failure manner without sign of yielding. As the DGEDA content further increased to 37.5%, the mixed epoxy resin started to show significantly high deformability and displayed yielding without break during testing. The flexural strength first increased with DGEDA content up to ˜40%. With 50% DGEDA, the mixed epoxy resin exhibited a strength almost same to that of neat DGEAPA. As DGEDA content increased further, however, the flexural strength of the mixed resin decreased rapidly. The flexible moiety of fatty acid that was introduced into the rigid fusing rings of rosin reduced the brittleness of the epoxy network. The flexural strength of sample (c) is 120.1 MPa which is ˜10% higher than that of neat rosin based sample (a), as well as the strain of sample c is almost twice of sample a. From a application perspective, rosin epoxy resin contains 20-40% of oil epoxy by weight performs the best toughness and utility. The similar results were reported in the strength improvement of diglycidyl ether of bisphenol A reinforced with epoxidized soybean oil.

### Example 15

### Thermal Stability

FIG. 13 shows the TGA results of cured resins with different DGEAPA/DGEDA ratios. The onset temperature of weight loss (Tₒ) and temperatures at which 5% weight loss (T_{5%}) was incurred are listed in Table 5. DGEDA had a lowest T_{5%} and Tₒ, being 275 and 229° C., respectively. The thermal stability of the cured epoxy resin decreased with increasing DGEDA content in the formulation. This decrease in thermal stability was probably due to the small amount of byproducts such as chlorohydrin esters that were not removed from DGEDA. Generally, the weight loss in the initial stage is caused by impurities which decompose or promote some decomposition ahead of the main thermal degradation. These impurities could also react with NMA to make incomplete cure and result in lower Tₒ. Tan also reported a similar result that the Tₒ of the epoxidized soybean oil based polyurethane was between 206 and 212° C. due to the incomplete cure.

TABLE 5
Thermal properties of cured epoxies
with different DGEAPA/DGEDA ratio

| | DGEAPA/DGEDA | | | | |
|---|---|---|---|---|---|
| | (% DGEDA in | | | | |
| Samples | epoxy mixture) | | Tₒ(° C.) | T_{5%}(° C.) | T_{g} (° C.) |
| a | 5:0 | (0) | 276 | 320 | 185 |
| b | 5:1 | (16.7%) | 265 | 308 | 163 |
| c | 5:3 | (37.5%) | 265 | 302 | 132 |
| d | 5:5 | (50%) | 252 | 288 | 114 |
| e | 1:5 | (83.3%) | 251 | 285 | 65 |
| f | 0:5 | (100%) | 229 | 275 | 43 |

Tₒ is the onset temperature of weight loss; T_{5%} is the temperatures at which 5% weight loss is incurred.

### Part II

### Examples 5-15: Summary

In the synthesis of glycidyl ester type epoxies, calcium oxide proved a good water scavenger in the dehydrohalogenation step and enabled the reaction to achieve a high product yield. In curing with nadic methyl anhydride, rosin-derived epoxy and dimer acid-derived epoxy exhibited very similar curing temperature windows and exothermic enthalpy. However, the former also had slightly higher activation energy, which was probably attributed to the diffusion control of the cure reactions of the rigid rosin-derived epoxy in the later stage. The flexural properties indicate that the addition of dimer acid-derived epoxy could significantly flexibilize and toughen rosin-derived epoxy resin. From the application perspective, the mixed epoxies containing 20-40 wt % of dimer acid-derived epoxy exhibited overall high performance DMA and TGA results showed that the T_{g}, storage modulus and thermal stability of the cured resin increased with increasing content of rosin-derived epoxy in the mixed resin. All results suggest that the rigid rosin-derived epoxy and the flexible dimer acid-derived epoxy were complementary in many physical properties and the mixture of the two in appropriate ratios could result in well-balanced properties. These results also demonstrate that rosin and fatty acid are potential useful feedstocks.

### Part III

### Examples 16-33

Materials:

Methyl esters of tung oil fatty acids were prepared by transesterification of tung oil and excess methanol. The product was a mixture of methyl esters of various fatty acids and contained 85% methyl eleostearate (GC-MS). Epichlorohydrin (99%, Acros organics), sodium hydroxide (98.7%, J. T. Baker), DER332 epoxy resin (epoxy equivalent weight 175 g/mol, The Dow Chemical Company), nadic methyl anhydride (99.4%, Electron Microscopy Sciences), hydroquinone (99%, Fisher), benzyltriethylammonium chloride (97%, Aldrich) and 2-ethyl-4-methylimidazole (99+%, Acros Organics) were used as received.

### Example 16

### Synthesis of Acrylo-Methyl Eleostearate (AME)

Methyl esters of tung oil fatty acids (100 g) and hydroquinone (0.25 g) were charged to a flask equipped with a stirrer, dropping funnel, inert gas inlet, thermometer, and reflux condenser. The temperature was raised to 160° C., and acrylic acid (24.7 g) was added slowly. The reaction continued for 5 h at 160° C. after all the acrylic acid was added. The excess acrylic acid was removed by vacuum first, and the crude product was distilled under a 5 mmHg vacuum. The fraction between 210 to 240° C. was collected, receiving 103 g acrylo-methyl eleostearate (yield: 97%). The acid value of AME is 152 mg/g (theory: 153 mg/g). ¹H-NMR (CDCl₃, δ ppm) 5.09-5.54 (m, 4H), 3.65 (s, 3H), 3.48-3.53 (q, 1H), 2.73-2.79 (m, 1H), 2.26-2.31 (t, 2H), 2.03-2.08 (m, 4H), 1.57-1.62 (m, 2H), 1.28 (m, 14H), 0.86-0.90 (t, 3H). ESI-MS m/z 363.3, [M−H⁺].

### Example 17

### Synthesis of C21DA

AME (100 g) and 20% NaOH solution (120.5 g) were charged to a flask equipped with a stirrer, thermometer, and reflux condenser. The temperature was raised to 95° C. and continued for 1 h. Then 1 mol/L H₂SO₄ solution was added into the reactants slowly until the PH value of the reactants was reduced to 7. Ethyl acetate was used to extract the organic layer and the organic layer was quenched with water for three times. After usual extractive work-up, anhydrous sodium sulfate was added to dry the product then the ethyl acetate was removed. 95 g white waxy solid was obtained (yield: 99%). The acid value of C21DA is 320.0 mg/g (theory: 320.6 mg/g). ¹H-NMR (CDCl₃, δ ppm) 5.15-5.60 (m, 4H), 3.52-3.55 (m, 1H), 2.75-2.82 (m, 1H), 2.31-2.36 (t, 2H), 2.13-2.17 (m, 2H), 1.89-1.97 (m, 2H), 1.29-1.33 (m, 14H), 0.87-0.91 (t, 3H). ESI-MS m/z 349.3, [M−H⁺].

### Example 18

### Synthesis of DGEC21

To a 50 mL flask equipped with reflux condenser, magnetic stirrer and thermometer were charged 3.500 g (10 mmol) C21DA, 18.500 g (200 mmol) epichlorohydrin and 0.023 g (0.1 mmol) benzyltriethyl ammonium chloride. The reaction temperature was raised to 117° C. and the reaction continued at that temperature for 2 h. After the mixture was cooled to 60° C., 0.800 g (20 mmol) sodium hydroxide and 1.120 g (20 mmol) calcium oxide were charged. The mixture was stirred at 60° C. for 3 h and then filtered by celite and filter paper. The salts were discarded. After the excess epichlorohydrin was distilled under vacuum at 100° C. from the filtrate, 4.263 g yellowish viscous resin was obtained. The product was purified using a silica gel column (ethyl acetate:hexane=1:4 v/v) to receive 3.632 g pure diglycidyl esters (yield: 85% relative to pure C21DA) with an epoxide equivalent weight 235 g/mol (theory: 231 g/mol). ¹H-NMR (CDCl₃, δ ppm) 5.06-5.59 (m, 4H), 4.36-4.41 (m, 2H), 3.81-3.95 (m, 2H), 3.09-3.21 (m, 2H), 2.77-2.83 (m, 2H), 2.74-2.77 (m, 1H), 2.57-2.63 (m, 2H), 2.29-2.34 (t, 2H), 2.00-2.10 (m, 2H), 1.86-1.96 (m, 2H), 1.58-1.62 (m, 2H), 1.28-1.43 (m, 14H), 0.84-0.89 (m, 3H), ESI-MS m/z 485.4, [M+Na⁺].

### Example 19

### Synthesis of Fumaric-Methyl Eleostearate (FME)

Methyl esters of tung oil fatty acids (1.00 g), fumaric acid (0.35 g) and acetic acid (1.75 g) were charged to a flask equipped with a stirrer, dropping funnel, inert gas inlet, thermometer, and reflux condenser. The reaction continued for 48 h at reflux. The acetic acid was removed by vacuum firstly. The residue was dissolved in dichloromethane, the excess fumaric acid precipitated and was removed by filtration. The crude product was purified by silica column (dichloromethane:methanol=10:1 v/v). Then 1.02 g AME was obtained (yield: 97% compared to the methyl eleostearate content in methyl esters of Tung oil fatty acids). The acid value of FME is 275.0 mg/g (theory: 275.0 mg/g). ¹H-NMR (CDCl₃, δ ppm) 5.08-5.63 (m, 4H), 3.66 (s, 3H), 3.07-3.13 (q, 1H), 2.50-2.67 (m, 2H), 2.36 (m, 1H), 2.27-2.32 (t, 2H), 1.99-2.09 (m, 2H), 1.58-1.61 (m, 2H), 1.27-1.41 (m, 14H), 0.86-0.91 (t, 3H). ESI-MS m/z 407.1, [M−H⁺].

### Example 20

### Synthesis of C22TA

The crude 129 g FME was dissolved in 500 mL acetone and neutralized by 50% NaOH solution drop by drop until the PH value is 7. After acetone was removed, 100 mL hexane and 400 mL water were added to separate the nonreactive methyl ester of fatty acids. The water layer was saponified by excess NaOH then was acidified by 1 mol/L HCl solution. The precipitated tricarboxyl acid was extracted by ethyl acetate. The organic layer was quenched by water and dried by NaSO₄ for 12 h then ethyl acetate was removed to obtain 98 g white solid product (yield: 99% relative to pure AME). The acid value of C22TA is 426.0 mg/g (theory: 427.2 mg/g). ¹H-NMR (DMSO, 6 ppm) 4.99-5.58 (m, 4H), 3.34 (m, 1H), 3.10 (t, 1H), 2.75-2.80 (q, 1H), 2.26-2.41 (m, 1H), 2.14-2.19 (t, 2H), 1.92-2.06 (m, 2H), 1.46 (m, 2H), 1.22-1.23 (m, 14H), 0.82-0.86 (t, 3H). ESI-MS m/z 393.2, [M−H⁺], 809.1, [2M−H⁺+Na⁺].

### Example 21

### Synthesis of TGEC22

To a 50 mL flask equipped with reflux condenser, magnetic stirrer and thermometer were charged 3.5 g (10 mmol) C22TA, 18.500 g (300 mmol) epichlorohydrin and 0.061 g (0.3 mmol) benzyltriethyl ammonium chloride. The reaction temperature was raised to 117° C. and the reaction continued at that temperature for 2 h. After the mixture was cooled to 60° C., 1.200 g (30 mmol) sodium hydroxide and 1.680 g (30 mmol) calcium oxide were charged. The mixture was stirred at 60° C. for 3 h and then filtered by celite and filter paper. The salts were discarded. After the excess epichlorohydrin was distilled under vacuum at 100° C. from the filtrate, 4.555 g yellowish viscous resin was obtained. The product was purified using a silica gel column (ethyl acetate:hexane=1:1 v/v) to receive 4.000 g diglycidyl esters (yield: 88% relative to pure C22TA) with an epoxide equivalent weight 193 g/mol (theory: 187 g/mol). ¹H-NMR (CDCl₃, δ ppm) 5.48 (m, 3H), 5.14 (dt, 1H), 4.35 (m, 3H), 3.94 (m, 3H), 3.17 (m, 4H), 3.08 (q, 1H), 2.73-2.85 (m, 4H), 2.55-2.69 (m, 3H), 2.36 (t, 2H), 2.08 (m, 3H), 1.61 (m, 2H), 1.32 (m, 14H), 0.88 (m, 3H), ESI-MS m/z 585.4, [M+Na⁺].

### Example 22

### Preparation of Cured Samples for Testing

In all formulations, epoxy and anhydride were maintained in the stoichiometric ratio, i.e., in a 1/2 molar ratio (i.e., 1/1 equivalent ratio). 2-Ethyl-4-methylimidazole was used as the catalyst and added at 1 wt % on the basis of total weight of curing agent and epoxy. The ingredients were mixed at 50° C., and then the mixture was charged into a steel mould (preheated at 120° C.) with cavity dimensions of 65×13×3 mm. Curing was performed at 120° C. for 2 h, 160° C. for 4 h. For ESO-NMA system, it was cured at 160° C. for 12 h. The cured specimens were carefully removed from the mould and used for flexural test, impact test, dynamic mechanical analysis (DMA) and thermogravimetric analysis (TGA).

### Example 23

### Characterizations

¹H-NMR spectra of the compounds in deuterated chloroform (CDCl₃) or deuterated dimethyl sulfoxide (DMSO) were recorded with a Bruker 300 MHz spectrometer at room temperature. Chemical shifts relative to that of chloroform (d 7.26) or DMSO (2.48) were reported. Mass spectra were recorded with an LCQ Advantage electrospray ionization mass spectrometry (ESI-MS) instrument. Viscosity of the epoxies and anhydrides were measured by Discovery HR-2 rheometer (TA). The sample was loaded in a 25 mm steel parallel plate with a gap of 500 μm and swept from shear rate 10 to 2.5 s⁻¹ at 25° C.

### Example 24

### Curing Kinetics

Curing kinetics was studied by differential scanning analysis (DSC) using a 2920 MDSC (TA Instruments) instrument. Epoxy and anhydride in a 1:1 equivalent ratio and 2-ethyl-4-methylimidazole (1 wt % on the basis of the total weight of curing agent and epoxy) were mixed. Approximately 5-10 mg of each sample was weighed and sealed in 40 μL aluminum crucibles and the curing on DSC was performed immediately. DSC analysis for each sample was repeated twice. The sample was scanned from 35 to 250° C. at heating rates of 5, 10, 15 and 20° C./min, respectively.

The basic assumption for the application of DSC technique to the cure of the thermosetting polymers is that the rate of the kinetics process (dαdt) is proportional to the measured heat flow dH/dt.

$$d α dt = Δ H / dt Δ H \frac{d α}{dt} - \frac{\frac{Δ H}{dt}}{Δ H} \qquad ( 1 )$$

ΔH being the enthalpy of the cure reaction, a being the conversion of the cure reaction.

For detailed information of the curing procedure, the Ozawa method was used to determine the activation energy during the curing. See T. J. Ozawa, Therm. Anal., 1970, 2, 301-324. The Ozawa method yields a simple relationship between the activation energy, the heating rate, and temperature at different conversion, giving the activation energy (Eₐ) as:

E=−R1.052Δ ln ØΔ(1/Ti) (2)

where φ is the heating rate, Tₚ the peak temperature of the DSC scanning curve and R the universal gas constant. The advantage here is that the activation energy can be measured over the entire course of the reaction.

### Example 25

### Dynamic Mechanical Analysis (DMA)

DMA of the blends were measured using a DMA Q800 (TA Instruments) in a single-cantilever mode with an oscillating frequency of 1 Hz. The temperature was swept from −50 to 250° C. at 3° C./min. For each sample, duplicated tests were performed in order to ensure the reproducibility of data. The glass-transition temperature (T_{g}) was determined as the temperature at the maximum of the tan δ versus temperature curve.

### Example 26

### Flexural Properties

Flexural properties was measured using a screw-driven universal testing machine (Instron 4466) equipped with a 10 kN electronic load cell according to ASTM D 790 at 25° C. The tests were conducted at a crosshead speed of 1 mm/min with a support span of 44 mm. All samples were conditioned at 50% RH and 25° C. for 4 days prior to tensile testing. Five replicates were tested for each sample to obtain an average value.

### Example 27

### Notched Izod Impact Strength

Notched izod impact strength was measured by Dynisco basic pendulum impact tester according to ASTM D 256-06. All samples were conditioned at 50% RH and 25° C. for 4 days prior to tensile testing. Five replicates were tested for each sample to obtain an average value.

### Example 28

### Thermogravimetric Analysis (TGA)

TGA was performed on a SDT Q600 TGA (TA Instruments) instrument. Each sample was scanned from 30 to 600° C. under a 100 mL/min nitrogen flow and a heating rate of 20° C./min.

### Example 29

### Synthesis and Characterization

FIG. 14 shows the ¹H-NMR spectra of AME, C21DA and DGEc21. The chemical shift of methoxyl at 3.65 ppm in AME disappeared in the spectrum of C21DA, which testified the ester completely hydrolyzed. In the spectrum of DGEC21, the chemical shift from 2.60-4.43 ppm indicated the protons of glycidyl ester groups. FIG. 15 displayed the ¹H-NMR spectra of FME, C22TA and TGEC22. Since C22TA is insoluble in CDCl₃, DMSO was used to dissolve C22TA. In the spectrum of TGEC22, the chemical shift at 2.55-4.35 ppm was attributed to the protons of glycidyl ester groups.

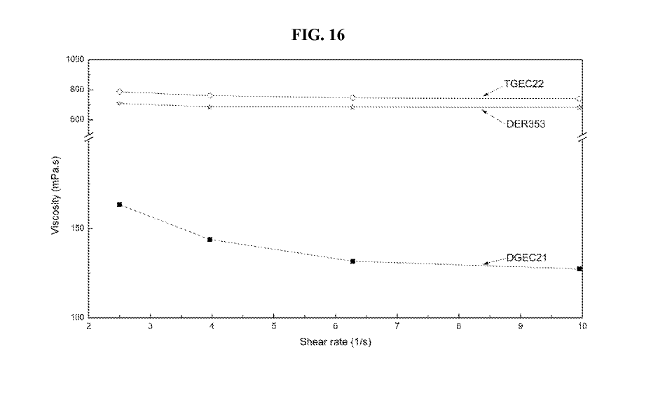

The viscosity of the prepared epoxies and anhydrides were also measured by rheometer and demonstrated in FIG. 16. The viscosity of DGEC21 at 2.5 s-1 is 163 mPa·s, while the viscosity of TGEC22 is 787 mPa·s which is close to the viscosity of DER353 at 25° C. (710 mPa·s). DER353 is a C12-C14 aliphatic glycidyl ether modified bisphenol A/F based epoxy resin of low viscosity from Dow company. This is a mono-functional reactive diluent modified liquid epoxy resin. Thus, DGEC21 and TGEC22 with such low viscosities could be used as the substitute for commercial reactive diluent in ambient curing coating/flooring formulations.

### Example 30

### Curing Behavior

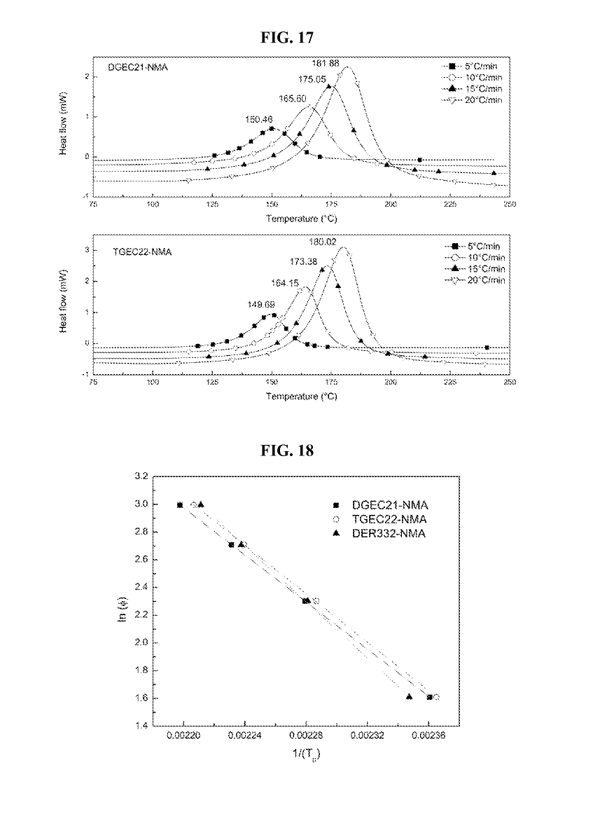

FIG. 16 shows the typical DSC thermograms of the epoxy/anhydride system at different heating rates. FIG. 17 displayed the plots of 1/(Tₚ) versus ln (φ) for calculating Eₐ. The DSC results calculated by the DSC curves at different heating rates are summarized in Table 6. Each sample exhibited only one exothermic peak during the non-isothermal curing. As the heating rate (φ) increased, peak exothermic temperature (Tₚ) shifted to higher temperatures. The shift of curing temperature with heating rate was a typical methodological phenomenon for non-isothermal curing. Nevertheless, the dependence of cure kinetics on heating rate could be eliminated by extrapolating the results to infinitely slow heating rates (isothermal conditions), yielding a “true” cure reaction temperature or an “true” enthalpy. See Vyazovkin, S.; Wight, C. A. Annu. Rev. Phys. Chem. 1997, 48, 125. Table 6 shows that the Tₚ at the zero heating rate is 142.1° C. for DGEC21/DPMA and 141.8° C. for TGEC22/DPMA, respectively. If the initial curing, peak and curing end temperatures at the zero heating rate can be used as references for the selection of temperatures in the isothermal curing study then these temperatures fell within the same range of the conventional epoxy curing temperatures. See Zvetkov, V. L. Polymer 2001, 42, 6687. The Tₚ at the zero heating rate of DER332 is 146.0° C. which indicated the two glycidyl ester type epoxy resins are more reactive than the bisphenol A type epoxy resin. Moreover, the activation energy also give another proof for this due to the Ea of DER332/NMA is 79.9 KJ/mol which is not higher than the Ea for DGEC21/NMA (67.2 KJ/mol) and TGEC22/NMA (69.2 KJ/mol).

TABLE 6
DSC results of Epoxy-Anhydride Thermosets

| Epoxy/anhydride | Tₚ (° C.)^{a} | Eₐ (KJ/mol) |
|---|---|---|
| DGEC21/NMA | 142.1 | 67.2 |
| TGEC22/NMA | 141.8 | 69.2 |
| DER332/NMA | 146.0 | 79.9 |

^{a}Linear extrapolation at φ = 0

### Example 31

### Dynamic Mechanical Analysis

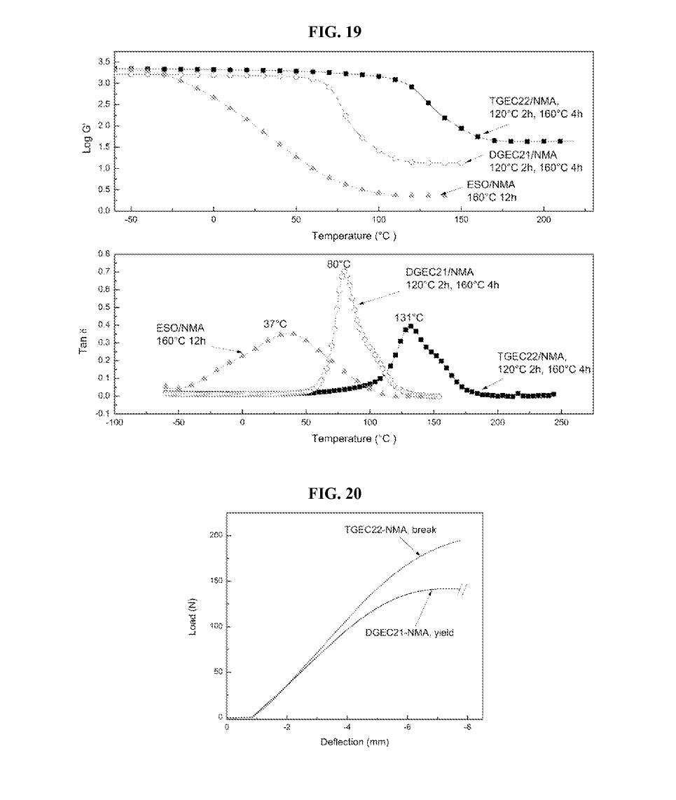

FIG. 19 shows the temperature dependence of loss factor (tan δ) and storage modulus (G′) of thermosets formulated with DGEC21-NMA, TGEC22-NMA, and ESO-NMA. DGEC21-NMA and TGEC22-NMA were cured at 120° C. for 2 h and 160° C. for 4 h, while ESO-NMA system were cured at 160° C. for 12 h due to the very low reactivity of ESO. The T_{g} of ESO/NMA is only 37° C. The T_{g} of DGEC21/NMA and TGEC22/NMA thermosets are 80° C. and 131° C., respectively. Even epoxy equivalent of ESO is 237 g/mol which is very close to that of DGEC21 (235 g/mol). For TGEC22, increasing epoxide concentration led to increased cross-link density and an increase in the T_{g}. Because of the much shorter aliphatic chains and a portion of alicyclic structure, the storage modulis of DGEC21 and TGEC22 are much higher than that of ESO, which proved that these two epoxides derived from tung oil are suitable for substituting some commercial epoxy resins.

### Example 32

### Flexural Properties and Notched Izod Impact Strength

FIG. 20 shows the representative load-deflection curves of the cured DGEC21-NMA and TGEC22-NMA. The flexural properties and notched izod impact strength are displayed in Table 7. The thermosets of DGEC21 and NMA exhibited yielding behavior without breaking during test. The cured TGEC22/NMA broke in the test and showed a higher load. The flexural modulus, stress and strain of DGEC21/NMA are 2211.4 MPa, 88.6 MPa and 8.1%, respectively. As for TGEC22/NMA, its flexural modulus, stress and strain are 121.4 MPa, 2621.3 MPa and 8.7%, respectively. It was notable that higher crosslink density made a slight increase in modulus but a great improvement in flexural stress from DGEC21 to TGEC22. The flexural stress of TGEC22/NMA almost reached the corresponding value of commercial epoxy DER332/NMA (126.6 MPa). However, because of the oil based flexible nature, the modulus of TGEC22 was still lower than the modulus of bisphenol A type epoxy resin.

The notched izod impact strength of these cured materials were also measured. In Table 7, the DGEC21 and TGEC22 derived from tung oil performed impact strengths of 9.3 and 7.9 KJ/m². Both of them are higher than the impact strength of DER332/NMA system. This indicated the flexible segment of the in tung oil based epoxy network contributed to the promotion of impact property.

TABLE 7
Flexural and impact properties of cured
DGEC21-NMA, TGEC22-NMA and DER332-NMA

| | | | | impact |
|---|---|---|---|---|
| | Flexural properties | | | strength |
| Sample | Stress (MPa) | modulus (MPa) | strain % | (KJ/m²) |
| DGEC21-NMA | 88.6 ± 2.1 | 2211.4 ± 56.4 | 8.1 ± 0.2 | 9.3 ± 1.3 |
| TGEC22-NMA | 121.4 ± 2.0 | 2621.3 ± 65.4 | 8.7 ± 0.2 | 7.9 ± 1.4 |
| DER332-NMA | 126.6 ± 30.1 | 3524.6 ± 124.6 | 6.3 ± 0.9 | 7.7 ± 1.2 |

### Example 33

### Thermal Stability

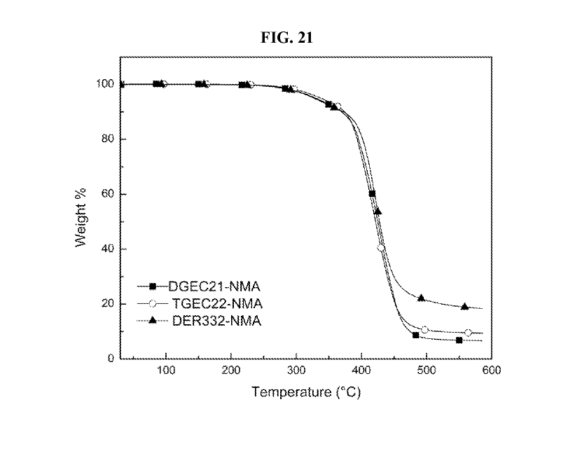

The thermal stabilities of the epoxy-anhydride thermosets were studied using TGA in nitrogen. FIG. 21 shows the TGA results for DGEC21/NMA, TGEC22/NMA and DER332/NMA. The char yield rate at 585° C. and temperatures at which 5% weight loss (T_{5%}) and 10% weight loss (T_{10%}) was incurred are listed in Table 8. In FIG. 21, it is seen that these three cured epoxy networks performed very similar weight loss curves at the initial stage. Table 8 shows a comparison of T_{5%}, T_{10%} and char yield rate of the thermosets. T_{5%} of DGEC21/NMA is 329.8° C. which is close to that for DER332/NMA. TGEC22/NMA has a little lighter T_{5%} of 337.6° C. As for T_{10%}, three thermosets have almost the same value. The char yield of DER332/NMA is higher than the other two aliphatic epoxy resins because of the presence of aromatic moieties. See Sergei V Levchik, Edward D Weil, Polymer International, 2004, 1901-1929. Thus, it comes to a conclusion that the thermal stability of the tung oil based epoxy resin are almost as good as that of commercial epoxy resin.

TABLE 8
Thermal properties of cured epoxies

| Epoxy/anhydride | T_{5%} (° C.) | T_{10%} (° C.) | Char yield rate at 585° C. |
|---|---|---|---|
| DGEC21/NMA | 329.8 | 368.9 | 6.7% |
| TGEC22/NMA | 337.6 | 373.6 | 9.4% |
| DER332/NMA | 327.1 | 371.5 | 18.4% |

### Part III

### Examples 16-33: Summary

The tung oil based epoxy resin described herein has a potential to replace commercial bisphenol A type epoxy resins. As described, two glycidyl esters were successfully synthesized from tung oil. Viscosities of glycidyl esters were as low as that of commercial reactive diluent for epoxy resins. Also, these two fatty acid glycidyl esters are more reactive than commercial bisphenol A epoxy resin and can more easily achieve complete cure conversion through the common curing procedure for epoxy/anhydride thermosets. DMA indicated that the thermosets cured with anhydride have much higher T_{g} and storage modulus than the cured ESO material. Flexural properties and impact strength showed that TGEC22 and DGEC21 have the competitive properties compared to bisphenol A epoxy resin. TGA also revealed that the tung oil based epoxy resin have the similar thermal stability of commercial epoxy resin. These kinds of glycidyl esters with rigid properties, low viscosity and high heat resistance could have a potential to replace bisphenol A epoxy resin. They could be used as electron sealing resins, reactive epoxy diluents, electrical insulating materials and epoxy self-levelling flooring.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (for example, “such as”) provided herein, is intended merely to better illuminate the embodiments and does not pose a limitation on the scope of the claims unless otherwise stated. No language in the specification should be construed as indicating any non-claimed element as essential.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

While certain embodiments have been illustrated and described, it should be understood that changes and modifications can be made therein in accordance with ordinary skill in the art without departing from the technology in its broader aspects as defined in the following claims.

1. A compound of Formula I: 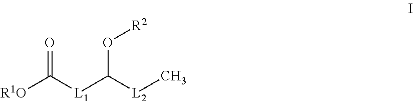
wherein
R¹ is H, alkyl or 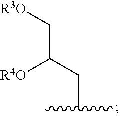
R³ and R⁴ are independently 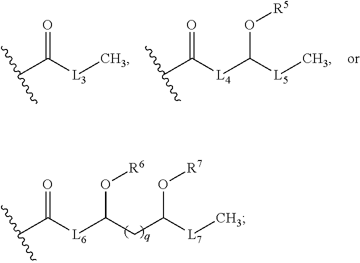
R², R⁵, R⁶ and R⁷ are independently CO(CH₂)ₘSH, CO(CH₂)ₘP(O)(OR⁸)(R⁹), P(O)(OR¹⁹)₂, P(O)(OH)₂, COC(R¹⁰)═CHR¹⁹ or COC(R¹⁰)═CH₂;
R⁸ is H, alkyl, or aryl;
R⁹ is H, alkyl, or aryl;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene or C₂-C₂₂ alkenylene;
m is 1 to 6; and
q is 1 to 6.

2. The compound of claim 1, wherein where R⁸ and R⁹ are each an aryl, and R⁸ and R⁹ are joined together by a single bond.

3. The compound of claim 1, wherein the compound is of Formula II: 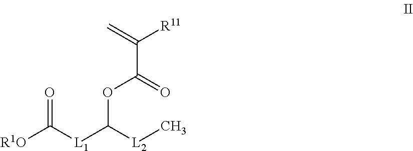
wherein
R³ and R⁴ are independently 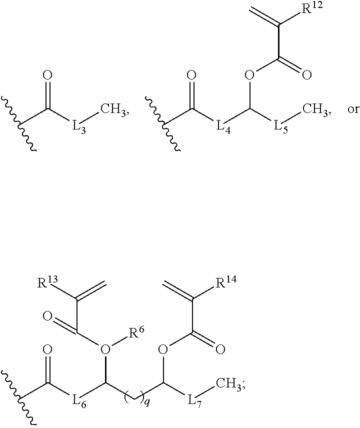
R¹¹, R¹², R¹³ and R¹⁴ are independently H, halo, alkyl, alkenyl, alkynyl, alkoxy, ester or CN; and
q is 1 to 6.

4. The compound of claim 1, wherein R¹ is H or

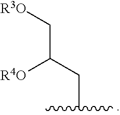

5. (canceled)

6. The compound of claim 3, wherein R¹¹, R¹², R¹³ and R¹⁴ are all H or methyl.

7. (canceled)

8. The compound of claim 1 which is:

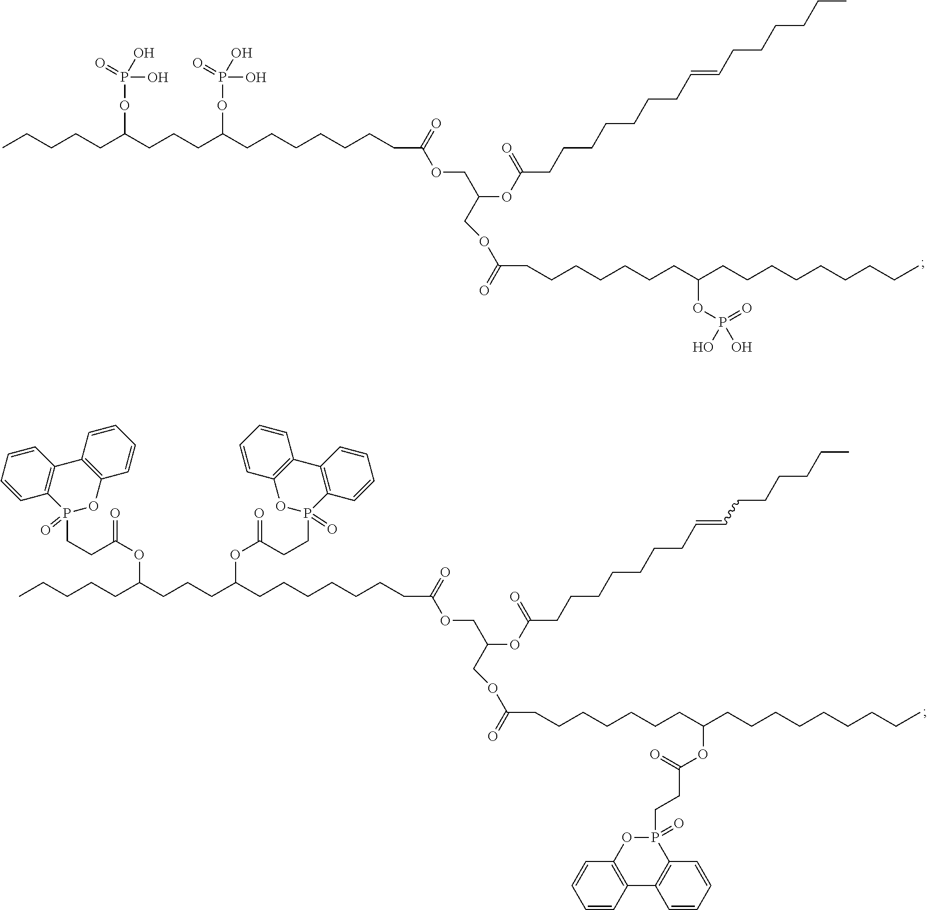 [SMILES: CCCCCC/C=C/CCCCCCCC(=O)OC(COC(=O)CCCCCCCC(CCCCCCCCC)OP(=O)(O)O)COC(=O)CCCCCCCC(CCCC(CCCCC)OP(=O)(O)O)OP(=O)(O)O ; CCCCCCC=CCCCCCCCC(=O)OC(COC(=O)CCCCCCCC(CCCCCCCCC)OC(=O)CCP1(=O)Oc2ccccc2-c2ccccc21)COC(=O)CCCCCCCC(CCCC(CCCCC)OC(=O)CCP1(=O)Oc2ccccc2-c2ccccc21)OC(=O)CCP1(=O)Oc2ccccc2-c2ccccc21]

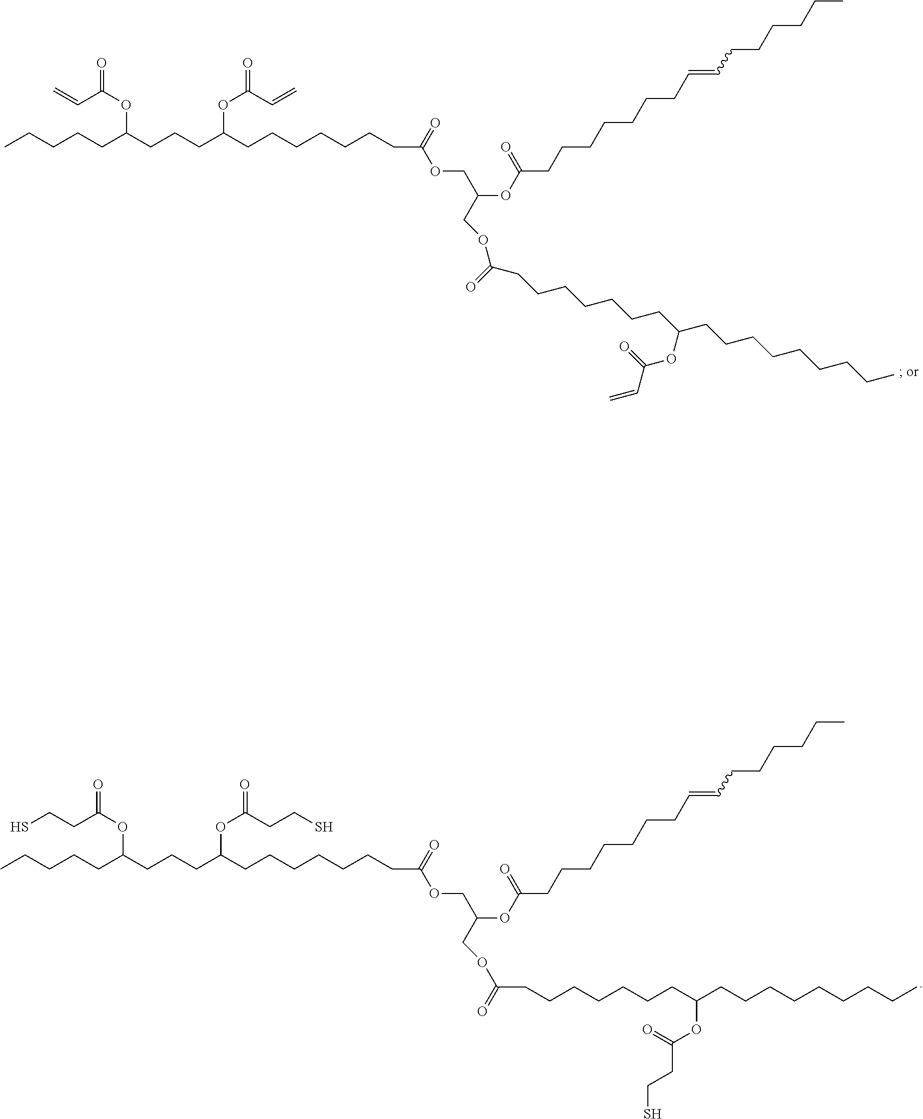

9. (canceled)

10. A compound of Formula Ia: 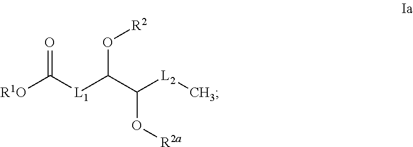
wherein
R¹ is H, alkyl or 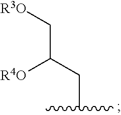
R³ and R⁴ are independently 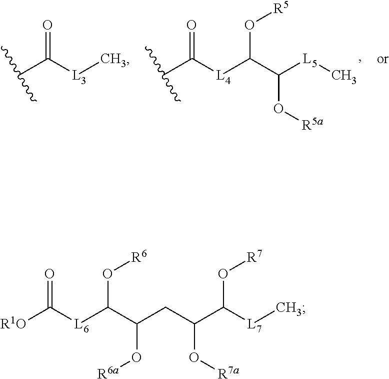
R², R⁵, R^{5a}, R⁶, R^{6a}, R⁷ and R^{7a} are independently CO(CH₂)ₘSH, CO(CH₂)ₘP(O)(OR⁸)(R⁹), P(O)(OR¹⁹)₂, P(O)(OH)₂, COC(R¹⁰)═CHR¹⁹, or COC(R¹⁰)═CH₂;
R⁸ is H, alkyl, or aryl;
R⁹ is H, alkyl, or aryl; or
R⁸ and R⁹ may both be aryl joined together by a single bond;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene; and
m is 1 to 6.

11. The compound of claim 10 which is:

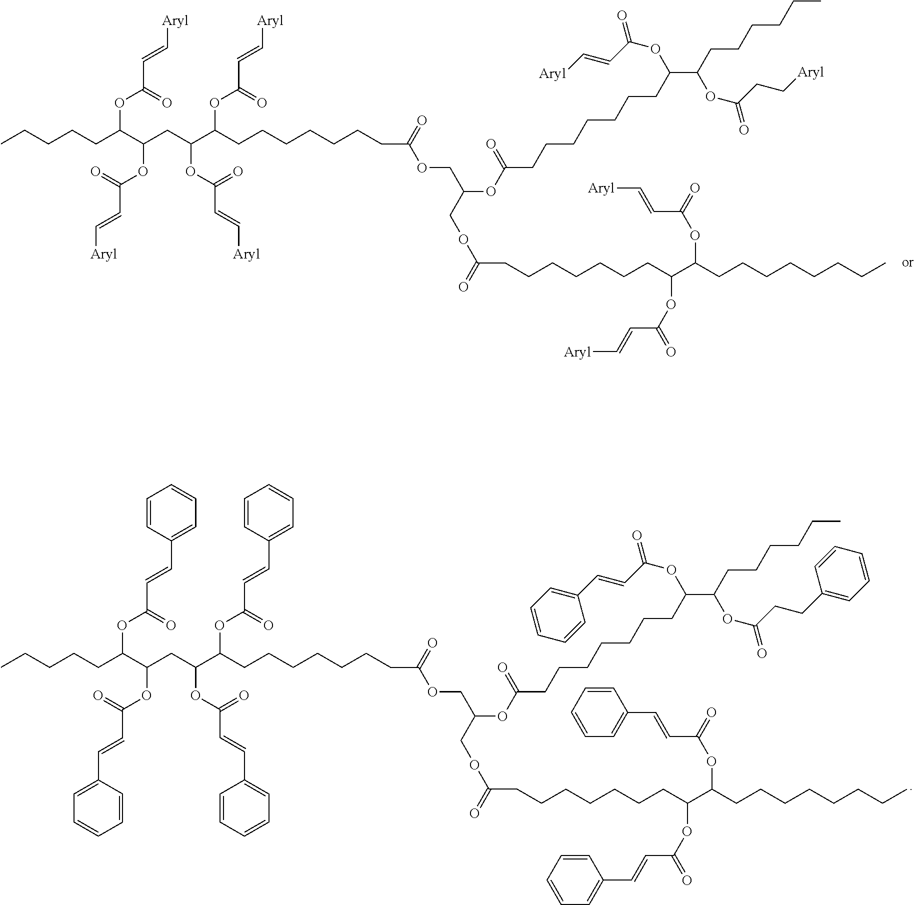

12. (canceled)

13. A co-polymer comprising a polymerization product of a polymerizable monomer with the compound of claim 1.

14. The co-polymer of claim 13, wherein the polymerizable monomer comprises a polymerizable group, PG¹.

15. The co-polymer of claim 14, wherein PG¹ is selected from the group consisting of isosorbide monoacrylyl, isosorbide diacrylyl, acrylyl, methacrylyl, epoxy, isocyano, styrenyl, vinyl, oxyvinyl, and a thiovinyl group.

16. The co-polymer of claim 13, wherein the co-polymer is of Formula III 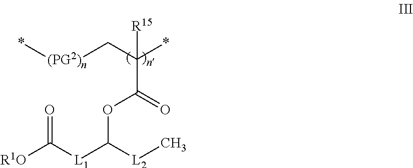
wherein
R¹ is H, alkyl, or 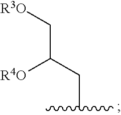
R³ and R⁴ are independently 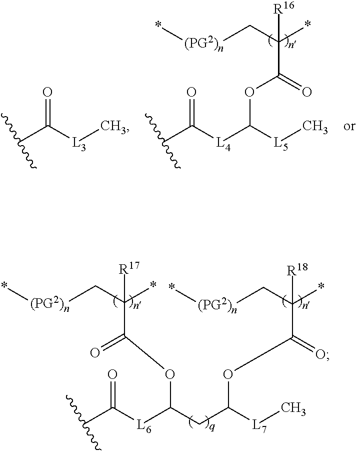
R¹⁵, R¹⁶, R¹⁷ and R¹⁸ are independently H, halo, alkyl, alkenyl, alkynyl, alkoxy, ester or CN;
PG² is the polymerized form of the polymerizable group PG¹;
each n and n′ is independently about 2 to about 100,000; and
q is 1 to 6.

17-20. (canceled)

21. A process for preparing a compound of Formula I, the process comprising:
mixing a compound selected from the group consisting of (HO)CO(CH₂)ₘSH, (HO)CO(CH₂)ₘP(O)(OR⁸)(R⁹), (HO)P(O)(OR¹⁹)₂, (HO)OP(O)(OH)₂ and (HO)COC(R¹⁰)═CH₂;
a catalyst; and
a C₈-C₃₀ unsaturated fatty acid or a C₈-C₃₀ unsaturated fatty ester to form the compound of Formula I: 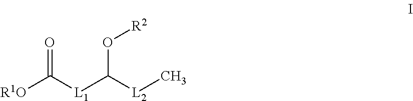
wherein
R¹ is H, alkyl or 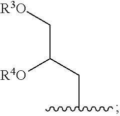
R³ and R⁴ are independently 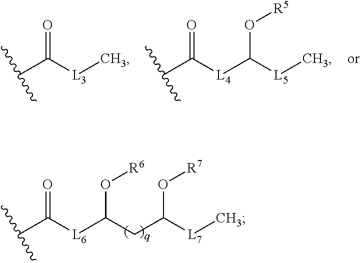
R², R⁵, R⁶ and R⁷ are independently CO(CH₂)ₘSH, CO(CH₂)ₘP(O)(OR⁸)(R⁹), P(O)(OR¹⁹)₂, P(O)(OH)₂ and)COC(R¹⁰)═CH₂;
R⁸ is H, alkyl, or aryl;
R⁹ is H, alkyl, or aryl;
R¹⁰ is H, halo, alkyl, alkenyl, alkynyl, alkoxy, ester or CN;
R¹⁹ is alkyl or aryl;
L₁, L₂, L₃, L₄, L₅, L₆ and L₇ are independently C₁-C₂₂ alkylene or C₂-C₂₂ alkenylene;
m is 1 to 6; and
q is 1 to 6.

22. The process of claim 21, wherein where R⁸ and R⁹ are each an aryl, and R⁸ and R⁹ are joined together by a single bond.

23. The process of claim 21, wherein the mixing comprises heating the compound, the catalyst, and the C₈-C₃₀ unsaturated fatty acid or the C₈-C₃₀ unsaturated fatty ester, to a temperature of about 60° C. to about 120° C.

24. (canceled)

25. The process of claim 21, wherein the catalyst is a Lewis acid catalyst.

26. (canceled)

27. The process of claim 21, further comprising adding a polymerization inhibitor to the compound, the catalyst, and the C₈-C₃₀ unsaturated fatty acid or the C₈-C₃₀ unsaturated fatty ester.

28. The process of claim 27, wherein the polymerization inhibitor is selected from the group consisting of tert-butylhydroquinone, 4-methoxyphenol, p-toluhydroquinone, 1,4-benzoquinone, hydroquinone, copper(I) chloride, iron(III) chloride and any combination of two or more thereof.

29. The process of claim 21, wherein the process is conducted in the absence of a solvent.

30-35. (canceled)

36. A compound prepared by the process of claim 21.

37-57. (canceled)
